(19) United States
(12) Patent Application Publication
(10) Pub. No.: US 2023/0402804 A1
(43) Pub. Date: Dec. 14, 2023

(54) SYSTEM AND METHOD FOR AUTOMATIC CRIMPING

(71) Applicant: Frisimos, Ltd., Kadima Zoran (IL)

(72) Inventors: Tal Pechter, Ramat HaSharon (IL); Hanan Ben-Ron, Herzliya (IL)

(73) Assignee: Frisimos, Ltd., Kadima Zoran (IL)

(21) Appl. No.: 18/207,430

(22) Filed: Jun. 8, 2023

Related U.S. Application Data
(60) Provisional application No. 63/350,105, filed on Jun. 8, 2022.

(51) Int. Cl. H01R 43/052; B25J 11/00

(52) U.S. Cl. CPC H01R 43/052; B25J 11/005

(57) ABSTRACT

A method and apparatus for automating one or more steps of a crimping process for crimping a crimp contact to a wire of a multi-wire cable is disclosed. Crimping wires is typically a labor-intensive process. As such, some or all of the manual steps may be automated, such as by manipulating one or more of the wires in preparation for inserting the wires into the crimping machine. In this way, the previously manually-operated machine may be less reliant or entirely non-reliant on manual labor.

### REFERENCE TO RELATED APPLICATION

The present application claims priority to U.S. Provisional Application No. 63/350,105, which is incorporated by reference herein in its entirety.

### TECHNICAL FIELD

The present disclosure generally relates to the cable and connector industry, and more particularly to crimping of multi-wire cables.

### BACKGROUND

Many types of cables may comprise multi-wire cables. Examples may include Ethernet, USB, HDMI and many custom cables. The above-mentioned cables may be made of cables wires connected to a connector using soldering or pressing all wires simultaneously to the connector (such as in the Ethernet cables).

An additional way of connecting cable wires to the connector is by using a method called crimp (or crimping). In this method, the cable may be stripped out of one or more protective layers, such as its outer jacket (and optionally shielding, to the extent shielding may be present), or other exterior of the cable. Then, one, some, or each wire may be stripped of its isolation at its end, thereby revealing the metal therein (e.g., copper). Thereafter, the metal may be crimped (e.g., mechanically crimped via an applied force) to a crimp contact (interchangeable termed a crimp or a terminal). More specifically, the wire may be inserted into the crimp contact. For example, the ire may be fully inserted into the crimp contact so that the end of the wire is flush with the exit of the c p contact in order to maximize cross-sectional contact. After which, the crimping tool (e.g., crimping pliers or other type of crimping device) applies a mechanical force in order to deform (e.g., compress and/or reshape) the crimp contact until it is cold-welded onto the wire. In this regard, crimping is a type of solderless electrical connector.

Various types of crimp contacts may be used. Merely by way of example, the contact may be a male contact, female contact or other types as well. After crimping, the crimped wires may be inserted into a connector or may be connected separately to a PCB or other destination. Further, various classes of wire crimps may be used, including closed barrel crimps (e.g., closed barrel crimps have a cylindrical opening for the wire, with the crimping tool deforming the originally circular cross section of the crimp contact into some other shape) or open barrel crimps (e.g., open barrel crimps have ears of metal that are shaped like a V or U, with the crimp contact bending and folding them over the wire prior to swage the wire to the crimp contact).

### BRIEF DESCRIPTION OF THE DRAWINGS

The accompanying drawings, which are incorporated in and constitute a part of this specification, illustrate various aspects of the invention and together with the description, serve to explain its principles. Wherever convenient, the same reference numbers will be used throughout the drawings to refer to the same or like elements.

FIG. 1A is a block diagram of one example layout in which an automated crimping machine may be placed within a plurality of other machines as part of a production line.

FIG. 1B is a first block diagram of the automated crimping machine.

FIG. 1C is a second block diagram of the automated crimping machine that integrates a robotic system with an at least partially manual crimping machine.

FIG. 2A is a top view of the cable stripped of one or more protective layers to expose the multiple wires therein.

FIG. 2B is a top view of the cable with the exposed multiple wires spread apart.

FIG. 2C is a top view of the cable rotated about theta (θ).

FIG. 2D is a top view of the cable with a nearest wire (to the respective wire for crimping) being individually manipulated in the a rotational direction.

FIG. 2E is a top view of the cable with a nearest wire (after one or more manipulations) being at least a predetermined distance from at least a part of the applicator.

FIG. 2F is a side view of the cable in order to position the wire of the cable in a predetermined position relative to the crimp contact in one or both of the Y direction or the Z direction.

FIG. 3 is a side view of the wire of the cable after having been crimped with the crimp contact.

FIG. 4 illustrates one example environment for the cable with multiple wires in which one wire is inserted within the applicator.

FIG. 5A illustrates another example of the exposed wires of the cable prior to being spread out.

FIG. 5B illustrates the exposed wires of the cable in FIG. 5A after having been spread out.

FIG. 5C illustrates the rotating of the cable about a rotation axis.

FIG. 5D illustrates insertion of a pin-like device in between two of the wires of the cable.

FIG. 5E illustrates one wire being moved axially by the pin-like device.

FIG. 5F illustrates a respective wire being inserted into the applicator.

FIG. 5G illustrates, after crimping the crimp contact onto a first respective wire, withdrawing the wire from the applicator.

FIG. 5H illustrates the pin-like device being moved to be adjacent to the first respective wire.

FIG. 5I illustrates the pin-like device moving the first respective wire to be further away from its nearest adjacent wire (e.g., the second respective wire).

FIG. 5J illustrates the pin-like device being moved to be adjacent to the second respective wire for crimping.

FIG. 5K illustrates the pin-like device moving the second respective wire in preparation for insertion into the applicator.

FIG. 5L illustrates the second respective wire after having a crimp contact crimped thereto and after removing the second respective wire from the applicator.

FIG. 5M illustrates the pin-like device moving the second respective wire to be further away from the third respective wire and closer to the first respective wire.

FIG. 5N illustrates that the cable may be rotated responsive to machine vision analysis.

FIG. 5O illustrates the pin-like device moving the third respective wire in preparation for insertion into the applicator.

FIG. 5P illustrates the third respective wire after having a crimp contact crimped thereto and after removing the third respective wire from the applicator.

FIG. 5Q illustrates the pin-like device moving the third respective wire to be further away from the fourth respective wire and closer to the first respective wire and the second respective wire.

FIG. 5R illustrates the pin-like device being moved to be adjacent to the fourth respective wire.

FIG. 5S illustrates the pin-like device moving the fourth respective wire in preparation for insertion into the applicator.

FIG. 5T illustrates the fourth respective wire after having a crimp contact crimped thereto and after removing the fourth respective wire from the applicator.

FIG. 5U illustrates the pin-like device moving the fourth respective wire to be further away from the fifth respective wire and closer to the first respective wire, the second respective wire, and the third respective wire.

FIG. 5V illustrates the pin-like device moving the fifth respective wire in preparation for insertion into the applicator.

FIG. 5W illustrates the fifth respective wire after having a crimp contact crimped thereto and after removing the fifth respective wire from the applicator.

FIG. 5X illustrates the pin-like device moving the fifth respective wire to be closer to the first respective wire, the second respective wire, the third respective wire, and the fourth respective wire.

FIG. 6 illustrates an example flow chart of one embodiment of the method.

FIG. 7 is a block diagram of an exemplary computer system that may be utilized to implement the methods described herein.

### DETAILED DESCRIPTION

As discussed in the background, one type of method for connecting cable wires to a connector is by crimping. In one or some embodiments, one, some, or all of the steps of crimping may be performed automatically (e.g., without any human input), such as by: automatically manipulating one or more of the wires (e.g., moving the respective wire for crimping, moving a nearest wire to the respective wire for crimping, spreading out one, some, or each of the wires in the cable); automatically manipulating the cable itself (e.g., rotating the cable along a rotation axis); automatically inserting an end of the respective wire into a specific section (e.g., the applicator) of a crimp machine; responsive to the insertion, automatically raising and/or lowering an end of the respective wire within the applicator; responsive to the insertion, automatically crimping the crimp contact to the respective wire; responsive to automatically crimping the crimp contact to the respective wire, automatically removing the respective wire from the crimp machine; responsive to automatically removing the respective wire from the crimp machine, automatically moving one or more of the wires of the multi-wire cable (e.g., the respective wire removed from the crimp machine and/or a nearest wire to the respective wire removed from the crimp machine); or responsive to automatically removing the respective wire from the crimp machine, automatically manipulating the cable itself (e.g., rotating the cable along a rotation axis).

In one or some embodiments, responsive to the crimp machine automatically sensing the insertion of the end of the wire into the specific section (e.g., the applicator) of the crimp machine, the crimp machine may automatically activate the crimp machine in order to apply an automatic mechanical force to crimp the crimp contact to the metal wire. As one example, a sensor, such as a proximity sensor, may be used in order to automatically detect the presence of the wire inserted in a portion of the crimp machine, such as through the crimp machine anvil or past the crimp machine anvil. As another example, a sensor, such as one or more cameras, may be used as part of a machine vision system in order to control the movement (e.g., controlling one or more motors) in order to move one or both of the respective wire or the applicator so that the respective wire is placed in a predetermined position within the applicator (e.g., moving in any one, any combination, or all of the X-direction, the Y-direction, the Z-direction, or the theta direction, as discussed further below).

Various proximity sensors are contemplated. For example, the proximity sensor may emit an electromagnetic field or a beam of electromagnetic radiation (e.g., infrared radiation) and may sense a change in the field or the return signal in order to determine whether the wire is proximate. Example proximity sensors comprise a capacitive proximity sensor, a photoelectric sensor, or an inductive proximity sensor (which may sense the metal wire). Responsive to automatically sensing the at least a part of the wire (e.g., the end of the wire) at a predetermined portion of the machine, the crimp machine may automatically activate a motive force device (e.g., a motor) in order to apply a mechanical force, such as a compressive force, in order to mechanically crimp the crimp contact to the end of the wire. Alternatively, responsive to automatically sensing the at least a part of the wire at a predetermined portion of the machine, the crimp machine may request the operator to press a button (or the like) in order to active the motive force device in order to apply a force in order to mechanically crimp the contact to the end of the wire. The crimp machine may have previously automatically grasped the crimp contact from a roll (e.g., a series of crimp contacts physically connected to one another), so that when the wire(s) is entered or inserted into the specific place or the predetermined portion in the machine (e.g., within the applicator), the crimp contact is positioned therein. In one or some embodiments, during the crimp, the crimp contact may actually be folded around the copper, thereby creating a strong physical and/or electrical connection between them.

Typical solutions for crimping may only handle either separate wires, or cable wires that are relatively long. In this way, the wires are parallelly brought next to each other and entered or inserted into the machine from the side. Other solutions use old machines no longer manufactured or self-made crimp machines that have a narrow working area, so that the wire ends may be relatively close to each other, and do not need to be largely spread. Designing a crimp machine of that sort is not feasible for a company that is not expert in crimp machines. As such, these solutions are not available today in the market.

In this regard, in certain instances, the length of the wire (e.g., the length at which a gripper may individually grip a wire separate from the main part of the cable) may be shorter, such as less than 50 mm, less than 40 mm, less than 30 mm, less than 25 mm, less than 20 mm, less than 15 mm, less than 10 mm, etc. As such, in one or some embodiments, for a respective wire to be crimped, the respective wire itself is not held: when inserting the respective wire into the applicator; and/or when the respective wire is within the applicator (including when the respective wire is moved upward and/or downward within the applicator and/or when the respective wire is being crimped to the crimp contact within the applicator); and/or when withdrawing the respective wire from the applicator. Rather, in one, some, or each of these instances, the cable itself (e.g., the protective shielding) is held.

More particularly, as discussed in more detail below, the crimp contact is placed (e.g., inserted) in an applicator. After which, the wire is inserted into the applicator so that the wire is pushed deep enough inside the applicator so that the wire is positioned proximate and in predetermined relation relative to the crimp contact. Thereafter, the crimping tool applies the mechanical force to deform the crimp contact onto the wire. In this regard, the wire is inserted into the applicator. This means that for shorter wires, there is much less room for a gripper (or the like) to grip the wire and insert the wire into the application. For example, a wire may be less than 20 mm long (e.g., 17 mm) and the depth of the applicator may be at least 10 mm long (e.g., 13 mm). This means that there may be less than 10 mm of length of wire that is available to grip or hold the wire (e.g., 10 mm of a 20 mm wire is inserted into the applicator and therefore cannot be used to grip the wire or to hold the wire using a comb, leaving a remaining 10 mm of wire available for gripping or holding). Thus, in one or some embodiments, there may be less than 20 mm of length of wire that is available for gripping, less than 15 mm of length of wire that is available for gripping, less than 10 mm of length of wire that is available for gripping, less than 9 mm of length of wire that is available for gripping, less than 8 mm of length of wire that is available for gripping, less than 7 mm of length of wire that is available for gripping, less than 6 mm of length of wire that is available for gripping, less than 5 mm of length of wire that is available for gripping, less than 4 mm of length of wire that is available for gripping, less than 3 mm of length of wire that is available for gripping, less than 2 mm of length of wire that is available for gripping, or less than 1 mm of length of wire that is available for gripping.

In this regard, crimping shorter wires may complicate the automatic crimping process in one of several ways including one or both of: (i) the potential inability to hold or grip the wires (e.g., instead only holding the cable itself); or (ii) the possibility of one or more adjacent wires (adjacent or proximate to the respective wire being crimped) interfering with the respective wire being crimped (e.g., an adjacent wire being inserted within the applicator or being crimped to the respective wire in error). In order to address these complications, one or two embodiments may be performed. In one or some embodiments, only one of the embodiments may be performed, which may address one or both of the complicating factors. Alternatively, the two embodiments may be performed separately and independently, which may address one or both of the complicating factors. Still alternatively, the two embodiments may be performed in combination, which may address one or both of the complicating factors.

In one embodiment, a part of the cable (such as one or both of the cable itself or a wire, such as the respective wire for crimping and/or one or more remaining wires in the cable) may be manipulated in any one, any two, any combination, or all of: an X-direction of the at least one wire; a Y-direction of the at least one wire; a rotational direction of the at least one wire; or a Z-direction of the at least one wire, wherein the rotational direction is in an X-Y plane, wherein the respective wire is inserted into the applicator in the Y-direction, and wherein after insertion of the respective wire into the applicator, a distance of a crimp contact within the applicator to the respective wire is in the Z-direction. These manipulations may be used in any one, any combination, or all of: (A) in preparation for inserting the respective wire into the applicator; (B) inserting the respective wire into the applicator; (C) after insertion of the respective wire into the applicator, moving the wire within the application (e.g., in the Y-direction and/or the Z-direction); or (D) after crimping the crimp contact to the wire, removing the respective wire from the applicator. Further, in one or some embodiments, any one, any combination, or all of these manipulations may be performed without holding one or more of the wires of the cable (e.g., without holding the respective wire that is being crimped and/or without holding other wires that have already been crimped or are scheduled to be crimped). In practice, the manipulation in any one, any combination, or all of the X-direction, the Y-direction, the Z-direction, or the rotational direction (e.g., the theta (θ), discussed further below) enables the automatic performance of one, some or all of the operations listed above within the narrow space allotted to work with the crimping machine and/or without holding the one or more of the wires of the cable (e.g., the respective wire subject to crimping and/or adjacent wires).

Alternatively, or in addition, a part of the cable (such as one or both of the cable itself or a wire within the cable, such as the respective wire for crimping, or one or more remaining wires in the cable) may be manipulated so that a nearest wire to the respective wire for crimping is at least a predetermined distance from at least a part of the applicator of the automatic crimping machine when the respective wire for crimping is inserted within the applicator. As discussed in more detail below, because the wires may be very short, the wires have a higher tendency to interfere with the crimping of the respective wire. Thus, in one or some embodiments, machine vision may be used in the predetermined positioning of one or more wires (e.g., the position of the respective wire, such as a direction of the tip of the respective wire; the position of the nearest wire to the respective wire).

In one or some embodiments, the machine vision (e.g., to determine the positioning of the one or more wires) may be performed prior to the movement of the one or more wires; after which, using the determining positioning of the one or more wires, the one or more wires may be manipulated to be positioned in a predetermined manner (e.g., moved to an absolute position and/or moved to a position relative to another object, such as relative to any one, any combination, or all of: relative to other wire(s); relative to a part of the applicator; or relative to the crimp contact placed within the applicator). Alternatively, or in addition, the one or more wires may be moved; after which machine vision may be used to determine and/or confirm the positioning. Based on the determined and/or confirmed positioning, the one or more wires may be further moved (e.g., moved to an absolute position and/or moved to a position relative to another object, such as relative to any one, any combination, or all of: relative to other wire(s); relative to a part of the applicator; or relative to the crimp contact placed within the applicator).

Various type of positioning using machine vision are contemplated. In one or some embodiments, the positioning comprises relative positioning (e.g., the positioning relative to any one, any combination, or all of: relative to a part of the applicator; relative to one or more other wires in the multi-wire cable; or relative to the crimp contact placed within the applicator), of the one or more wires and/or of the cable itself). Alternatively, or in addition, the positioning comprises absolute positioning (e.g., determining an absolute position in 2-D space and/or 3-D space). As discussed in more detail below, the positioning of the one or more wires and/or the cable itself may be in any one, any combination, or all of the X-direction, the Y-direction, the Z-direction, or the rotational direction, thereby allowing the freedom to automatically position one or both of the one or more wires or the cable itself in various positions.

Thus, in one or some embodiments, the respective wire may be positioned relative to the applicator and/or relative to one or more other wires in the cable at various stages of the crimping process (e.g., positioning the respective wire in predetermined relation to the applicator and/or to one or more other wires in the cable prior to insertion of the respective wire into the applicator; and/or positioning the respective wire in predetermined relation of at least a part of the applicator or the crimp contact positioned within the applicator while the respective wire is inserted within the applicator (e.g., modifying in the Y-direction and/or Z-direction as discussed further below); and/or positioning the respective wire in predetermined relation to the applicator and/or to one or more other wires in the cable after removal of the respective wire from the applicator). As merely one example, a direction of the tip of the respective wire may be analyzed relative to a part of the applicator (such as a chamber within the applicator into which the respective wire is to be inserted). Responsive to determining that the tip of the respective wire is misaligned with the part of the applicator (e.g., the tip is at least 2° off of the axis as formed by the chamber within the applicator; the tip is at least 3° off of the axis as formed by the chamber within the applicator; the tip is at least 4° off of the axis as formed by the chamber within the applicator; the tip is at least 5° off of the axis as formed by the chamber within the applicator; etc.), one or both of the position of the tip or of the part of the applicator may be moved to reduce the misalignment (e.g., to reduce the misalignment, the cable may be rotated so that the tip is less than 2° off of the axis as formed by the chamber within the applicator).

Alternatively, or in addition, adjacent or nearest wire(s) to the respective wire may be positioned relative to the applicator and/or relative to respective wire at various stages of the crimping process (e.g., positioning the nearest wire to the respective wire in predetermined relation to the applicator and/or to the respective wire prior to insertion of the respective wire into the applicator; and/or positioning the nearest wire to the respective wire in predetermined relation to the applicator and/or to the respective wire after removal of the respective wire from the applicator).

Positioning of the one or more wires in the cable may be performed in one of several ways. In one way, a pin-like device may be used. In practice, the pin-like device may be moved to be adjacent to or abut a particular wire (e.g., the respective wire for crimping, the adjacent wire, etc.). In this regard, the pin-like device may contact the particular wire at a single point or a single side of the wire in order to move the single wire (e.g., and only the single wire) to which it contacts. As one example, the pin-like device may be inserted between two wires and then moved to abut or contact one of the two wires. Alternatively, a gripping device may grip a wire (e.g., contact multiple points or opposites sides of the wire) and thereafter provide a motive force to move the wire.

In one or some embodiments, various sequences of movements are contemplated. In one or some embodiments, movement of the wires in the cable may comprise an initial spreading of the wires; after which, one or more individual wires may be moved in preparation for the respective wire's insertion into the applicator. For example, initially, the wires may be spread (e.g., individually spread) such that the wires form at least a predetermined angle between the respective wires. After the initial spreading, the wires may be moved further, such as by using the pin-like device, in order to increase the angle (which was formed in the initial spreading) between the respective wire and an adjacent wire in preparation for insertion of the respective wire into the applicator. In this regard, the initial spread may comprise a uniform spreading of the wires. After which, a more tailored movement of the wires may be effected in preparation for insertion of the respective wire into the applicator (e.g., moving one or both of the respective wire or the adjacent wire). As one example, the pin-like device may move the adjacent wire so that the angle formed by the adjacent wire and the respective wire increases. Alternatively, or in addition, the pin-like device may move the respective wire so that the angle formed by the adjacent wire and the respective wire increases. Further, in one or some embodiments, the cable may be rotated after the initial spreading, such as before or after increasing the angle between the respective wire and the adjacent wire in preparation for insertion of the respective wire into the applicator. As one example, after increasing the angle between the respective wire and the adjacent wire, machine vision may determine a direction of the respective wire. After which, the cable may be rotated (e.g., axially) and optionally moved laterally in order to line up the direction of the respective wire with the direction of the chamber within the applicator.

Thus, in one or some embodiments, for a multi-wire cable, the manipulation (e.g., the moving) of the one or more wires in the cable may result in in at least a predetermined non-zero angle being formed between at least two of the wires in the cable, between more than two of the wires in the cable, or between all of the wires in the cable. After manipulating the wires in the cable to the at least predetermined non-zero angle, one or both of the applicator or the cable is moved so that a respective wire is inserted into the applicator (e.g., after insertion, the respective wire is positioned within the applicator deeply enough inside so that the wire is flush with the exit of the crimp contact). Of note, in one or some embodiments, it is the cable (and not the respective wire for insertion into the applicator) that is held. As such, the shortness of the respective wire need not be an issue since the cable itself, and not the respective wire, is held as the wire is being inserted into the applicator.

Thus, in one or some embodiments, a system and method for auto crimping for multi-wire cables with short wire tips is disclosed. In one or some embodiments, the wires are spread out (e.g., at least two of the wires are spread at least 15° apart; at least two of the wires are spread at least 20° apart; at least two of the wires are spread at least 25° apart; at least two of the wires are spread at least 30° apart; at least two of the wires are spread at least 35° apart; at least two of the wires are spread at least 40° apart; at least two of the wires are spread at least 45° apart; at least two of the wires are spread at least 50° apart; at least two of the wires are spread at least 60° apart; at least two of the wires are spread at least 70° apart; at least two of the wires are spread at least 80° apart; at least two of the wires are spread at least 90° apart; etc.). In this way, the wires may be spread like a flower (e.g., some or all of the wires may be spread apart by at least 10°; some or all of the wires may be spread apart by at least 15°; some or all of the wires may be spread apart by at least 20°; some or all of the wires may be spread apart by at least 25°; some or all of the wires may be spread apart by at least some or all of the wires may be spread apart by at least 35°; etc.), and may be entered or inserted into the crimping machine (such as one-by-one into the crimping machine). For example, the wires may be spread across 180°. In the example of a 5-wire multi-wire cable, the angle between the different wires may be 45°. In one or some embodiments, the manipulation of the wires may be performed by robotics, such as robotics that are automatically controlled by a control system (e.g., a processor in combination with a memory).

In this regard, the disclosed system and method are configured to perform the spreading that may be in a large angle (e.g., at least tens of degrees between the wires), and then manipulating them one-by-one to the crimp machine.

In one or some embodiments, the level of difficulty may increase as the number of wires increase, and may likewise increase as the length of the tips decreases. For example, 3 wires of length 40 mm may be relatively easy to spread and manipulate whereas 5 wires of 19 mm length may be significantly more difficult to spread and manipulate. As the wire needs a minimum length for the part that is entering to the crimp machine, typically not much is left outside the crimp machine. For example, in one or some embodiments, at least 13 mm is needed in the crimp machine. In the example above of 19 mm length, this leaves 19−13=6 mm to the outside. The angle may be too big so that 180/5=36 degrees are not enough (180 degrees is the maximum theoretical spread for all wires together as the cable must be held from the front).

In one or some embodiments, a structure is used to spread the wires in a special manner, such as where the wires are still apart from each other and in an angle. In one or some embodiments, the angle may be selected so that the cable may be held by a gripper that has significant dimensions. The angle may be from the right or left. There are various ways contemplated to spread the wires. Regardless of the manner of spreading the wires, the spreading of the wires may be used in subsequent stages of the process.

In this regard, in one or some embodiments, a pin (interchangeably termed a pin-like device) or other similar device is used to manipulate the wires one-by-one. The pin may have various shapes, such as regular cylinder, such as sharp structure (e.g., a needle), such as a screwdriver (e.g., a flat-head screwdriver), a claw, or such as any other shape. As discussed in more detail below, one or more movements may result in the pin being positioned adjacent to a wire or in between two wires. In one embodiment, a motor may move the pin to be placed adjacent to the wire or in between the two wires. Alternatively, the wire may be moved to the pin so that the pin is placed adjacent to the wire or in between the two wires (e.g., the gripper (powered by a motor) may move the entire end of the cable to move the wires to the stationary pin). Still alternatively, both the pin and the wires may move so that the pin is placed adjacent to the wire or in between the two wires. In this way, the pin or similar structure may be inserted in between the wires and manipulate at least one of the wires via physical contact with the respective wire. The cable may be held in an angle, and the pin may push the wires to the crimp machine and then push it out of the machine after being crimped. In this way, the cable may be brought very closely to the crimp machine entrance.

In one or some embodiments, the movement between the wires and the pin is relative. In one embodiment, the system (such as the automatic robots in the system) may move the pin while the cable is held stationary, and by the pin moving controlling the angle of the wires. Alternatively, the system may maintain the pin in a stationary position while the cable is moved so as to control the angle of the wires. Still alternatively, both the pin and the cable may be moved relative to one another.

In any instance, as discussed above, the cable and/or the pin may be moved in any one, any combination, or all of: the X-dimension; the Y-dimension; the Z-dimension; or rotationally as to have the desired flexibility (e.g., the maximum flexibility) in directing the wires to place.

In one or some embodiments, manipulation of one or more wires does not move one, some or all of the remaining wires. In this way, the next wire to be handled may be easily put apart from the other wire(s) using the pin.

Thus, the disclosed system and method may enable automatically crimping multi-wire cables, such as sufficiently complex multi-wire cables that are in use in the market today. Without the disclosed system, the only viable option is manually manipulation of the wires, which is the current state of the art. Today, the typical dimensions of wire tips are around 17 mm to 24 mm, which is very short for the existing solutions in the market today. As such, the disclosed system and method may automatically manipulate wire tips around 17 mm to 24 mm without requiring manual manipulation.

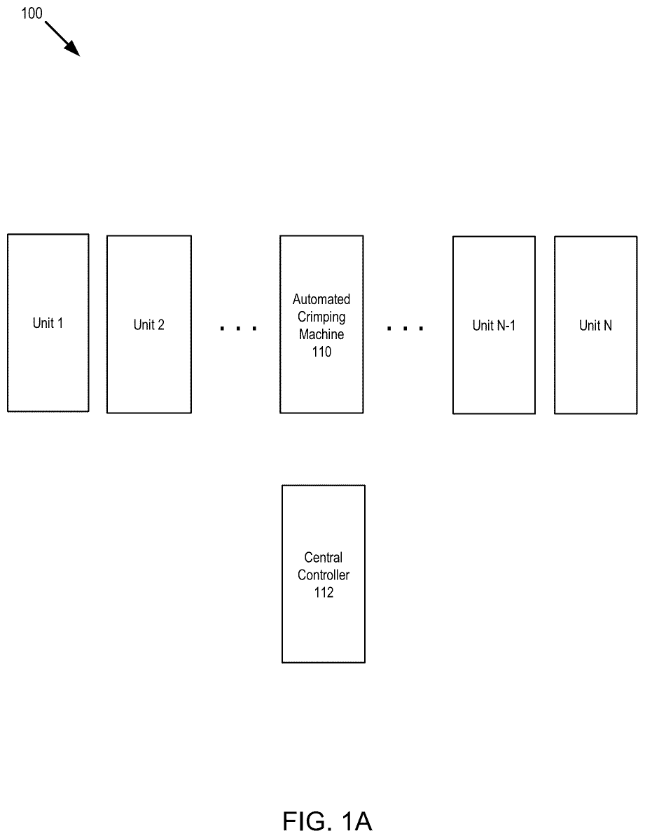

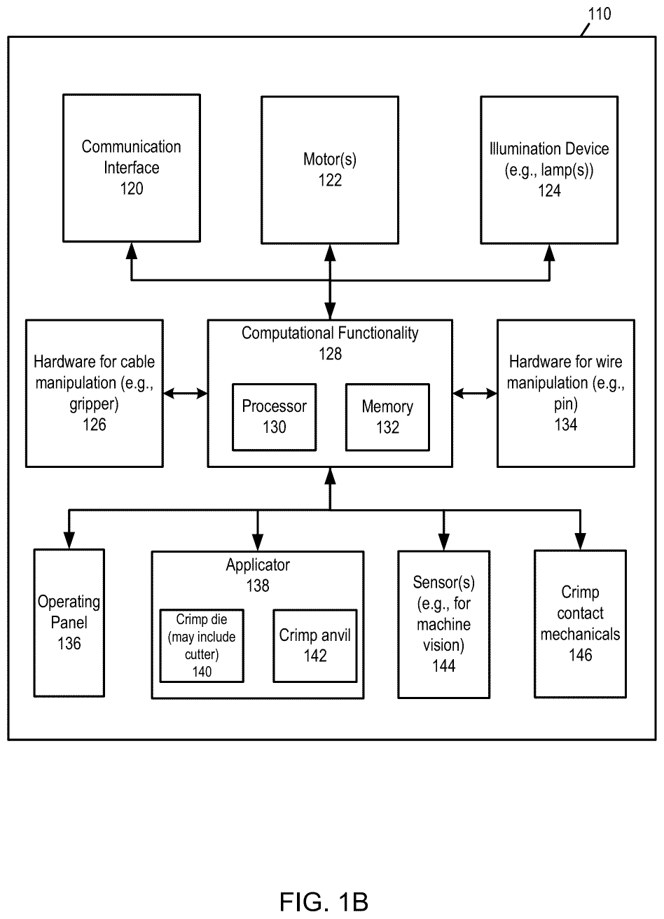

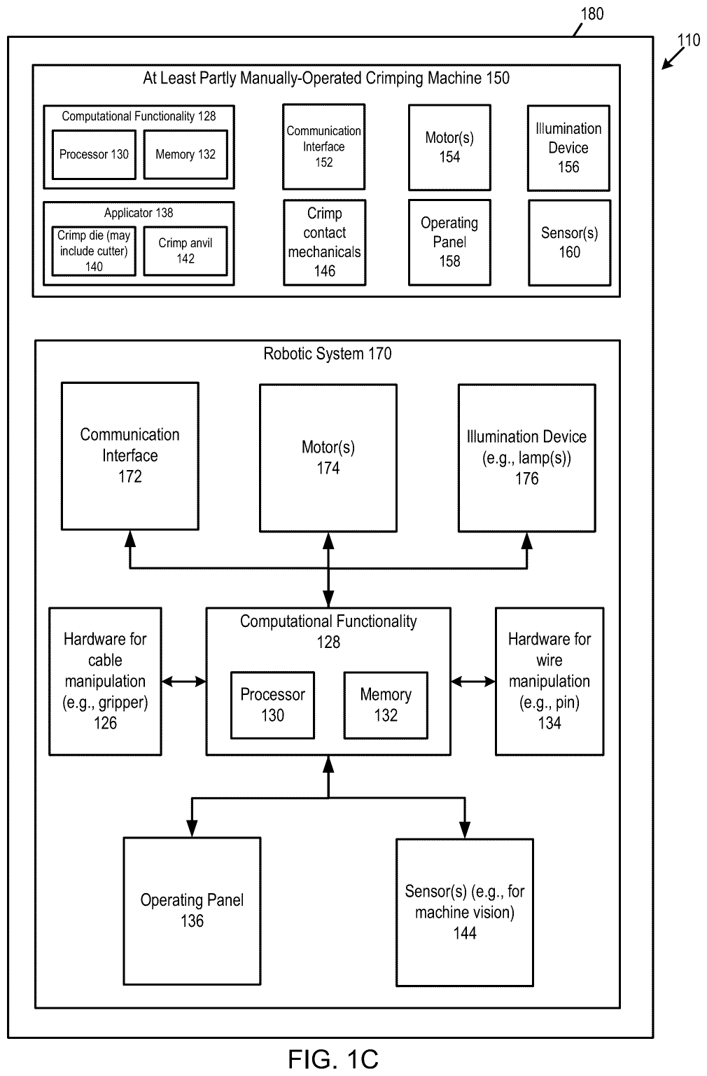

Referring to the figures, FIG. 1A is a block diagram of one example layout in which an automated crimping machine (interchangeable termed an automatic crimping machine) may be placed within a plurality of other machines as part of a production line. Specifically, in one embodiment, the automated crimping system and automated crimping method may be part of a standalone solution. Alternatively, the automated system and automated method may be part of an automatic line, such as illustrated in FIG. 1A, which is a block diagram of one example layout 100 in which an automated crimping machine 110 may be placed within a plurality of other machines as part of a production line (such as an at least partly automatic production line or an entirely automatic production line), which may further include one or more other units, such as unit 1, unit 2, . . . unit N−1, unit N. Further, a central controller 112 may be configured to communicate with the automated crimping machine 110 and/or with the one or more other units. In one or some embodiments, other units on the production line may include an automatic wire stripper machine and/or an automatic wire spreader machine.

The automated crimping machine 110 may be implemented in one of several ways. In one way, the automated crimping machine 110 may comprise a single system that is designed as automated. See FIG. 1B. In another way, the automated crimping machine 110 may comprise two separate systems that integrate with one another (e.g., within a single housing) in order to form the automated crimping machine 110. For example, the two separate systems may comprise an at least partially manually-operated crimping machine 150 and a robotic system 170 that automatically performs one, some, or each of the manually-operated tasks needed to operate the at least partially manually-operated crimping machine 150. See FIG. 1C. In this way, the robotic system may operate in combination with an existing partially automated crimping system (e.g., as a retrofit). Or, the robotic system may operate in combination with a previously-designed partially automated crimping system.

In particular, FIG. 1B is a first block diagram of the automated crimping machine 110. The automated crimping machine 110 may include any one, any combination, or all of: a communication interface 120; one or more motors 122; illumination device 124; hardware for cable manipulation 126; computational functionality 128; hardware for wire manipulation 134; operating panel 136; applicator 138; sensor(s) 144; and crimp contact mechanicals 146.

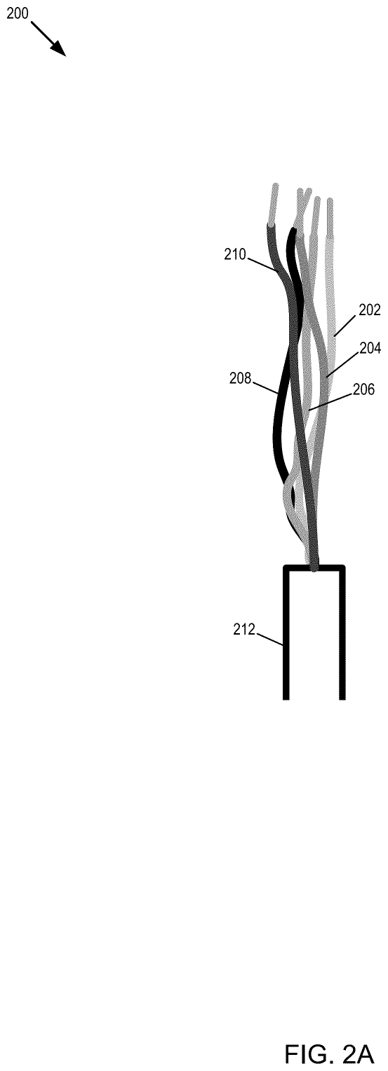

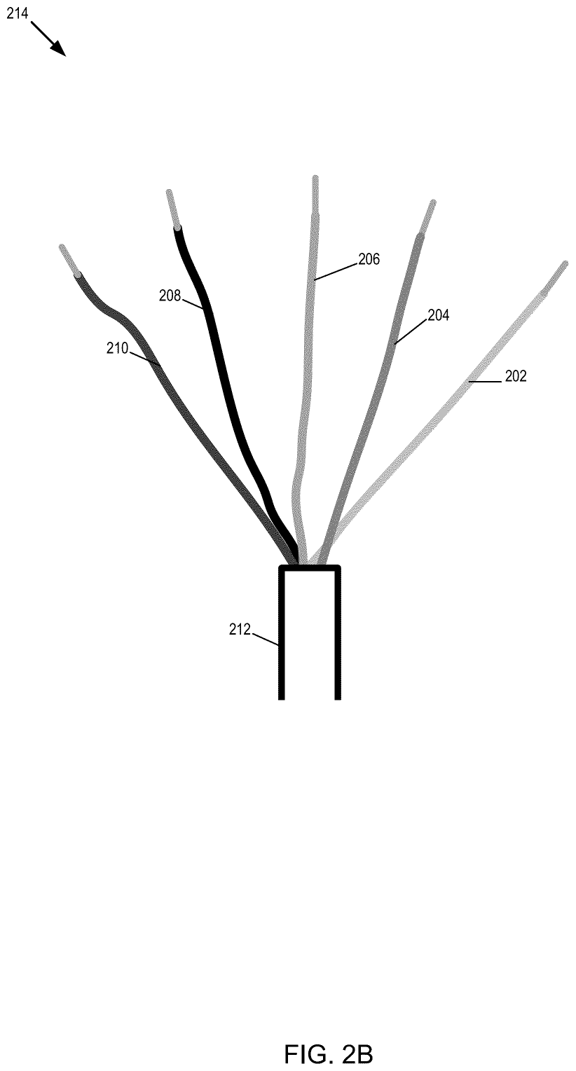

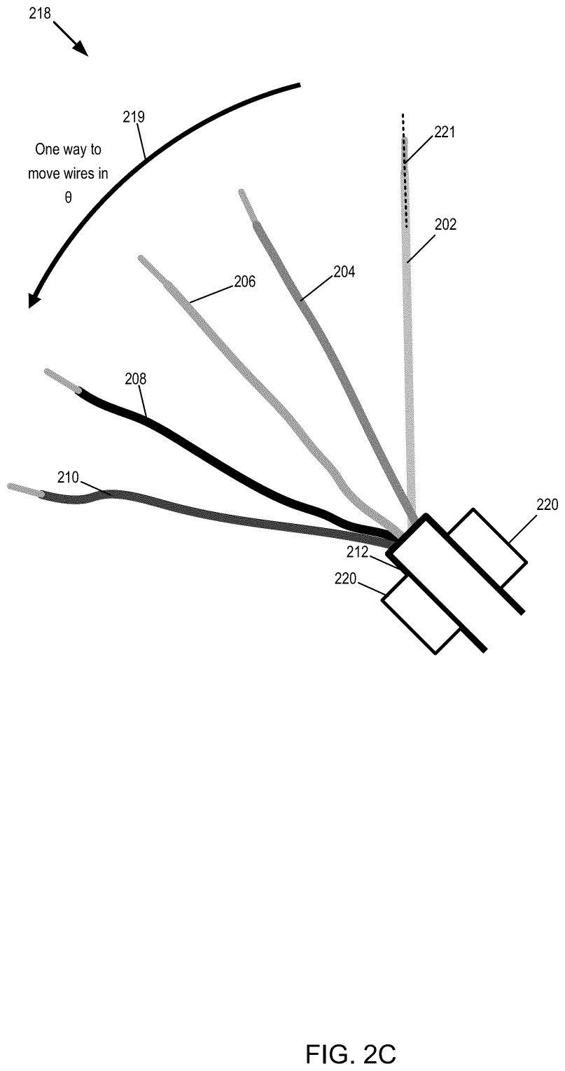

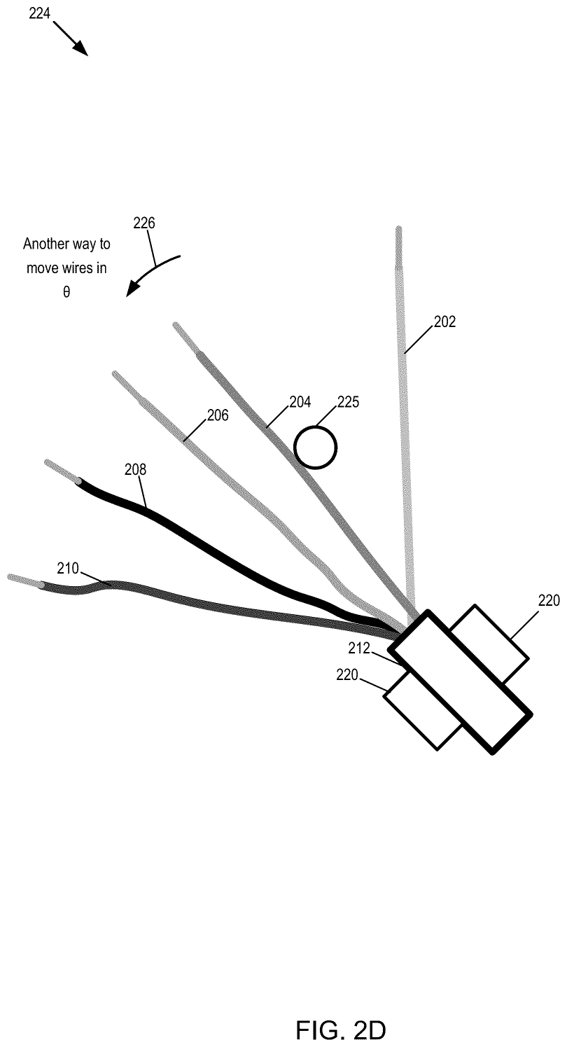

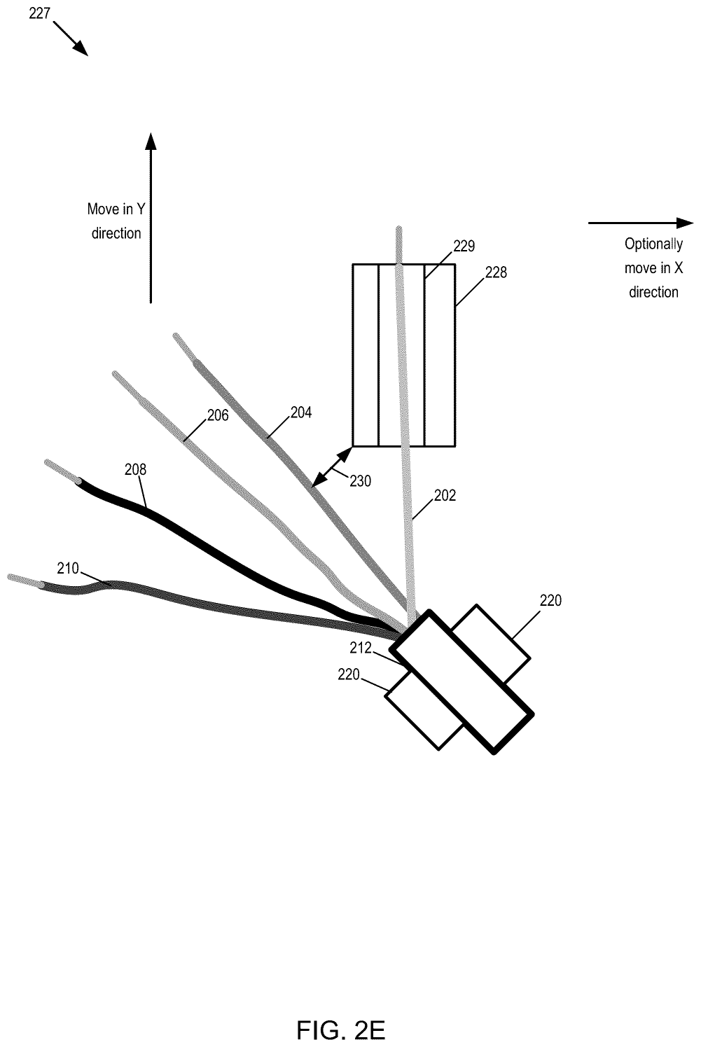

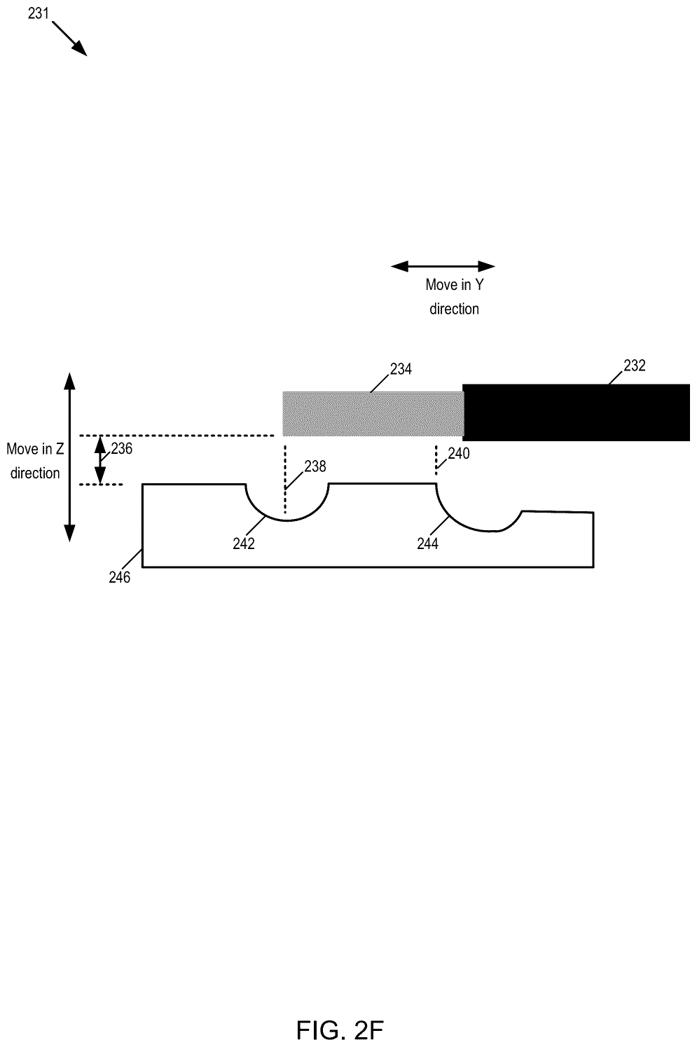

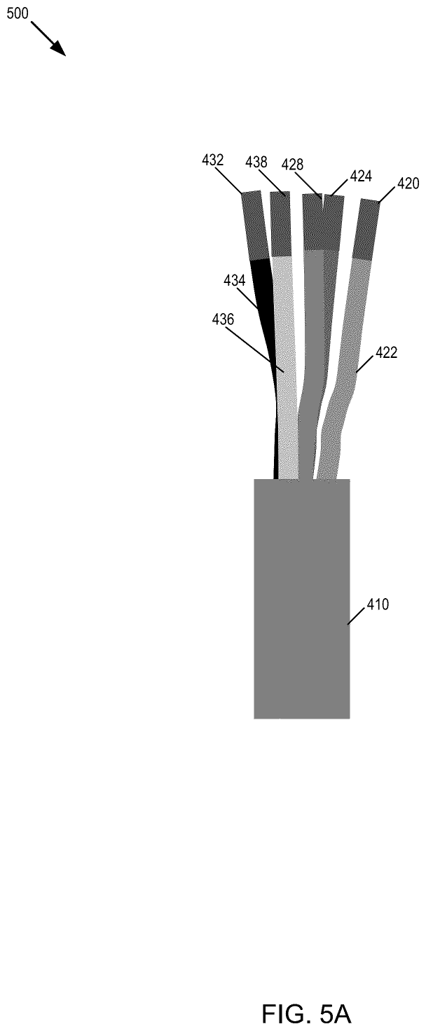

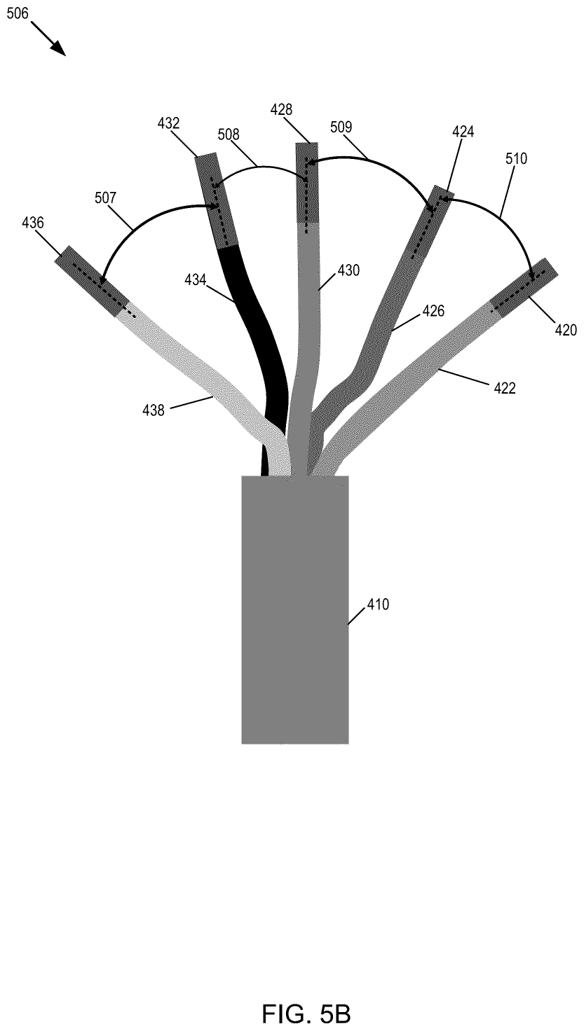

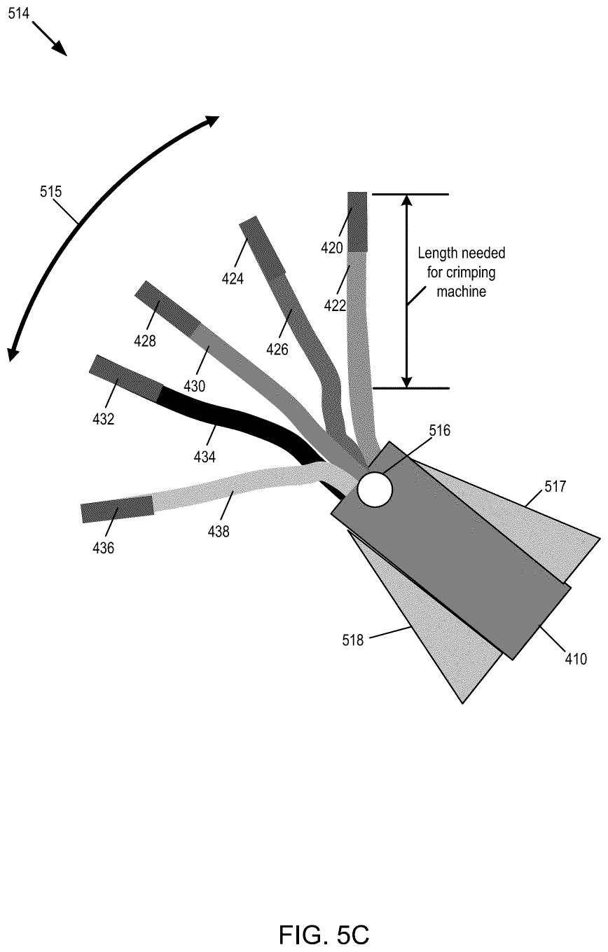

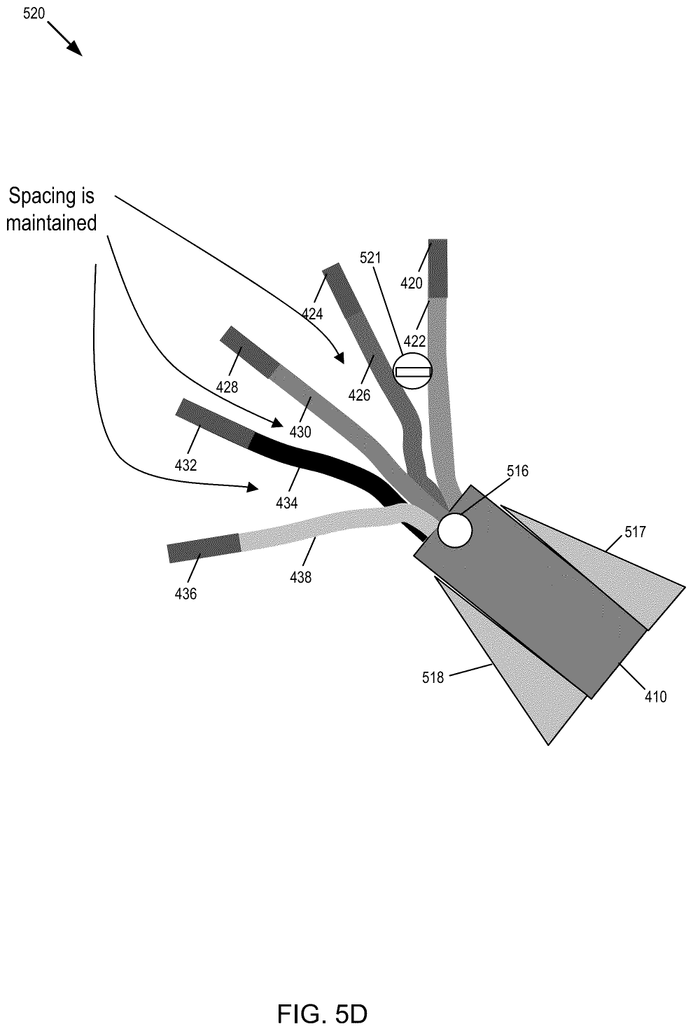

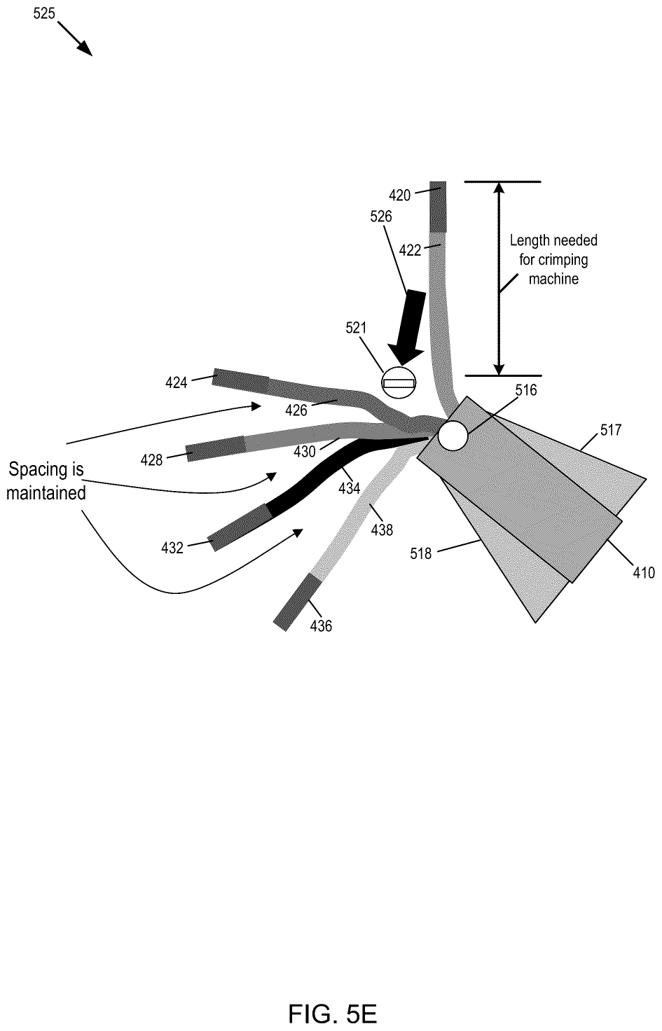

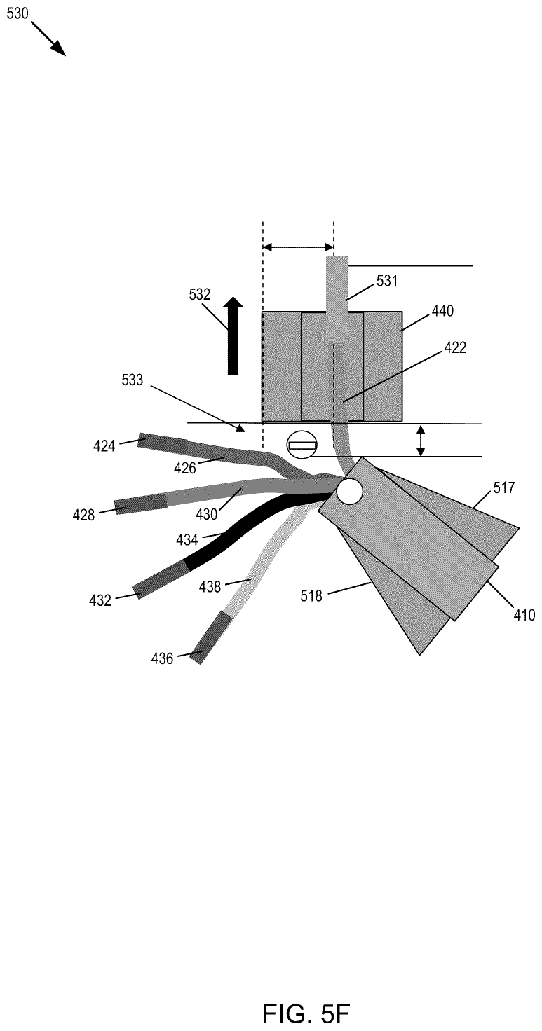

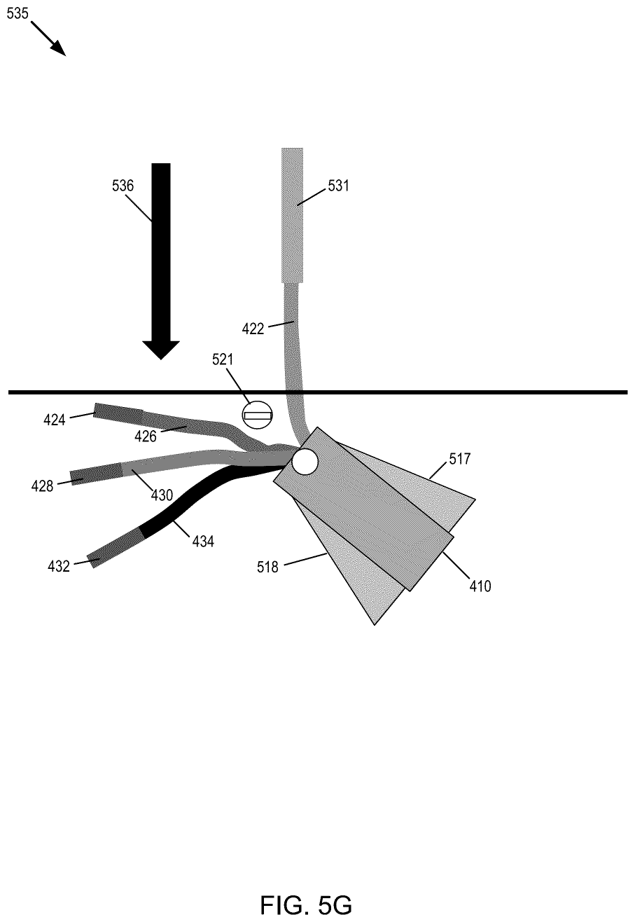

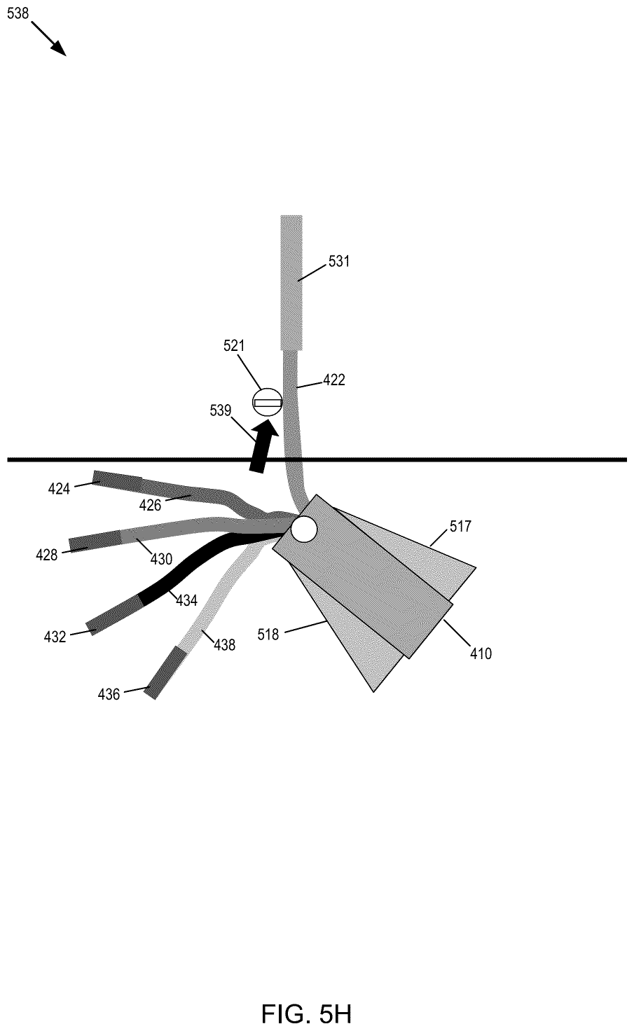

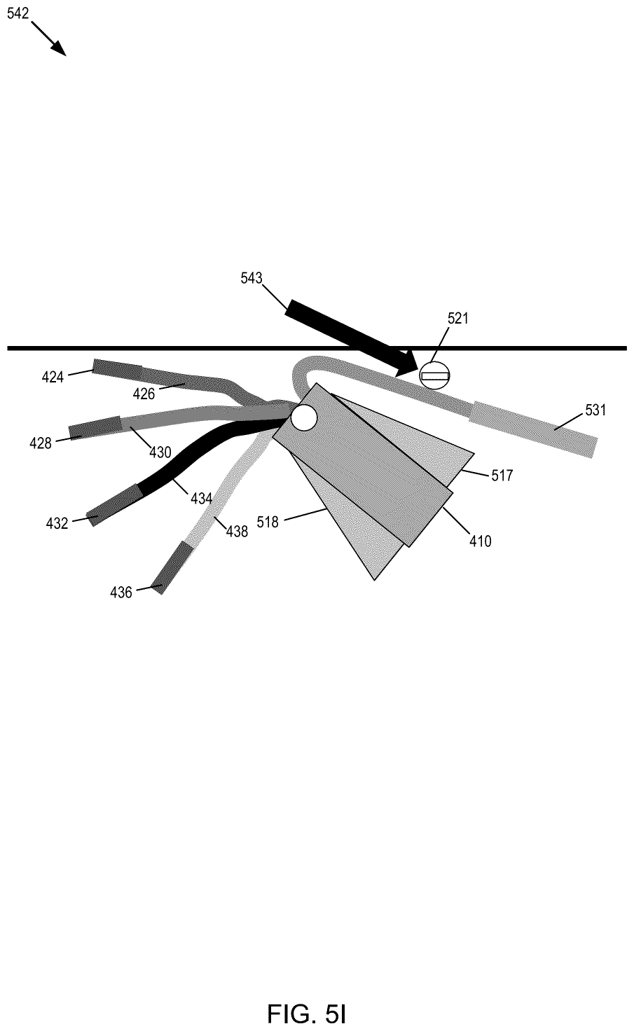

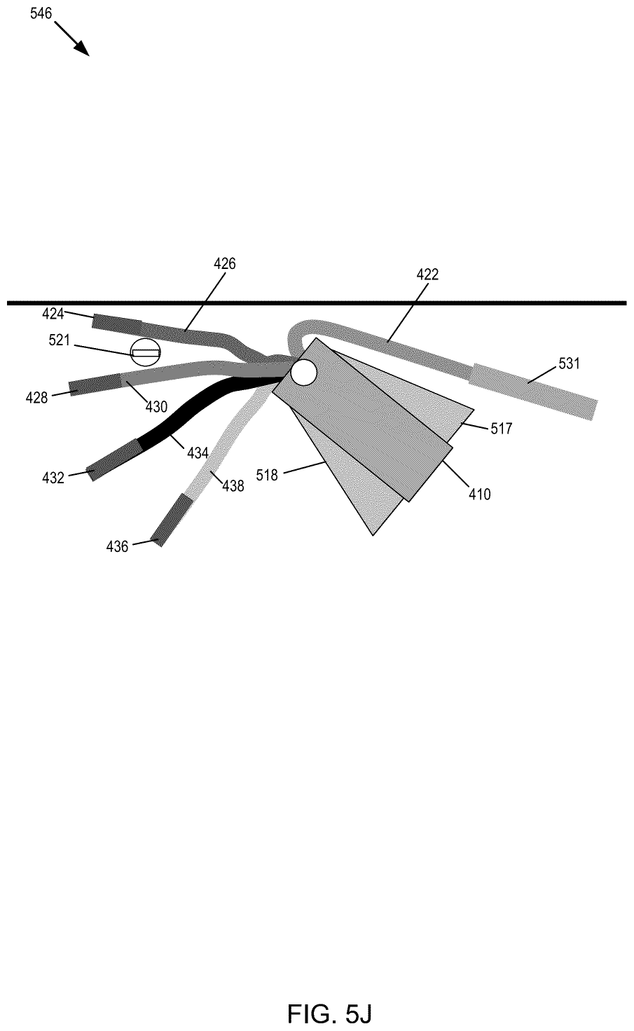

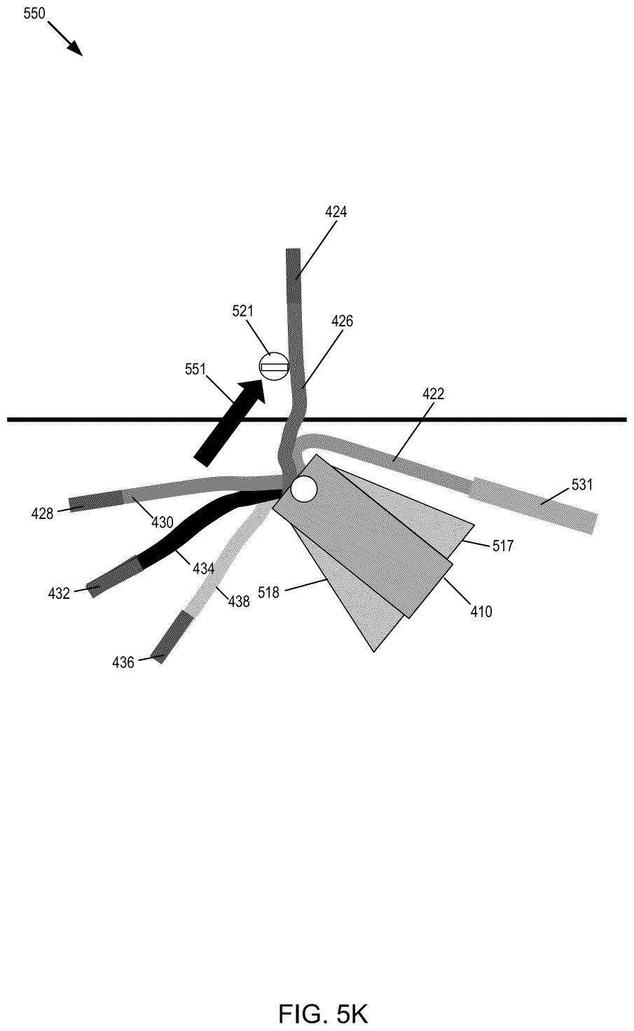

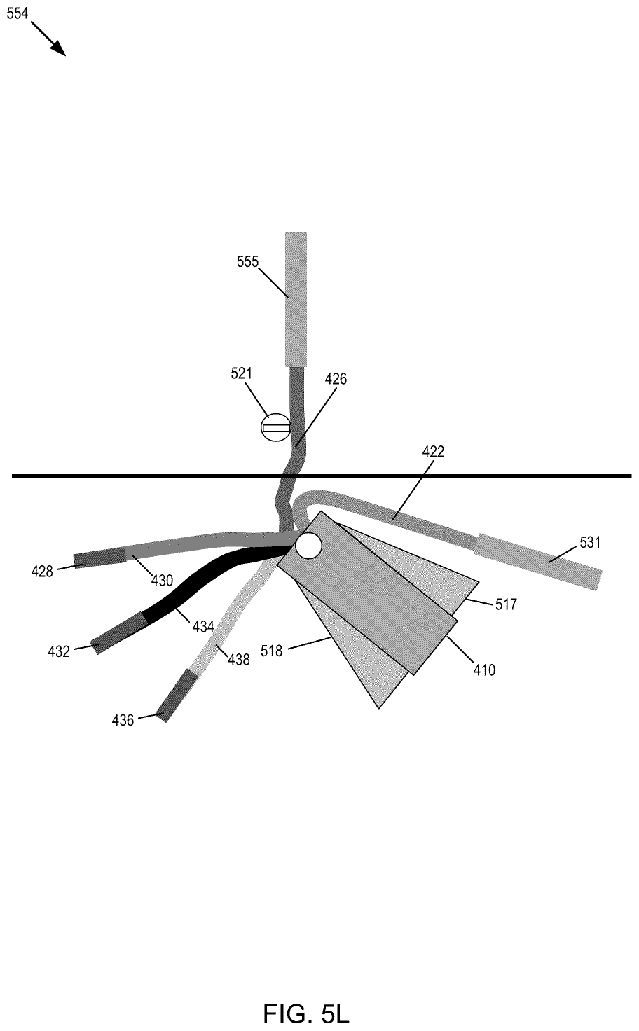

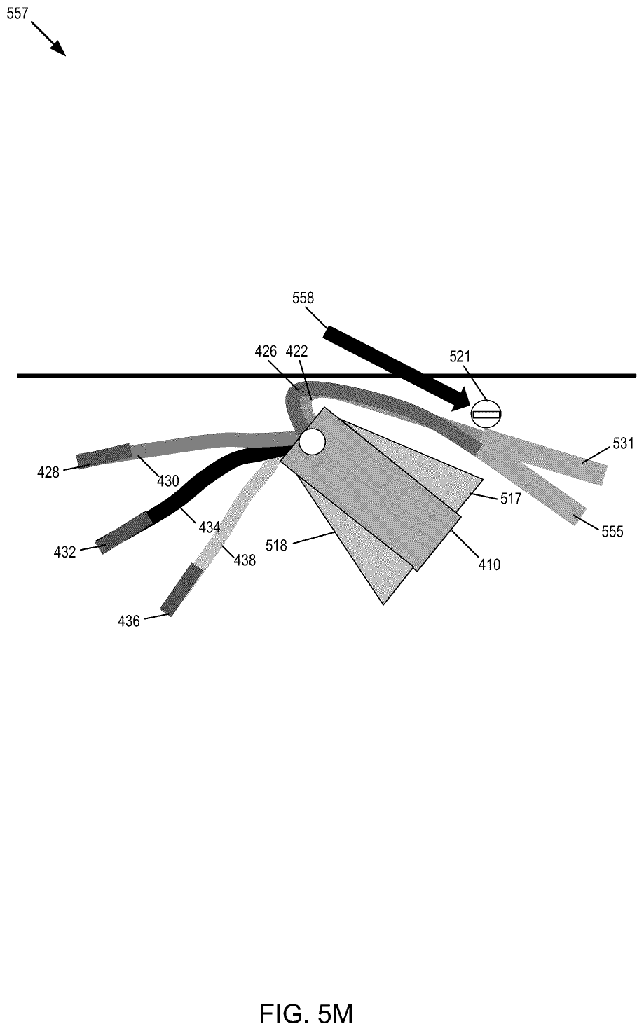

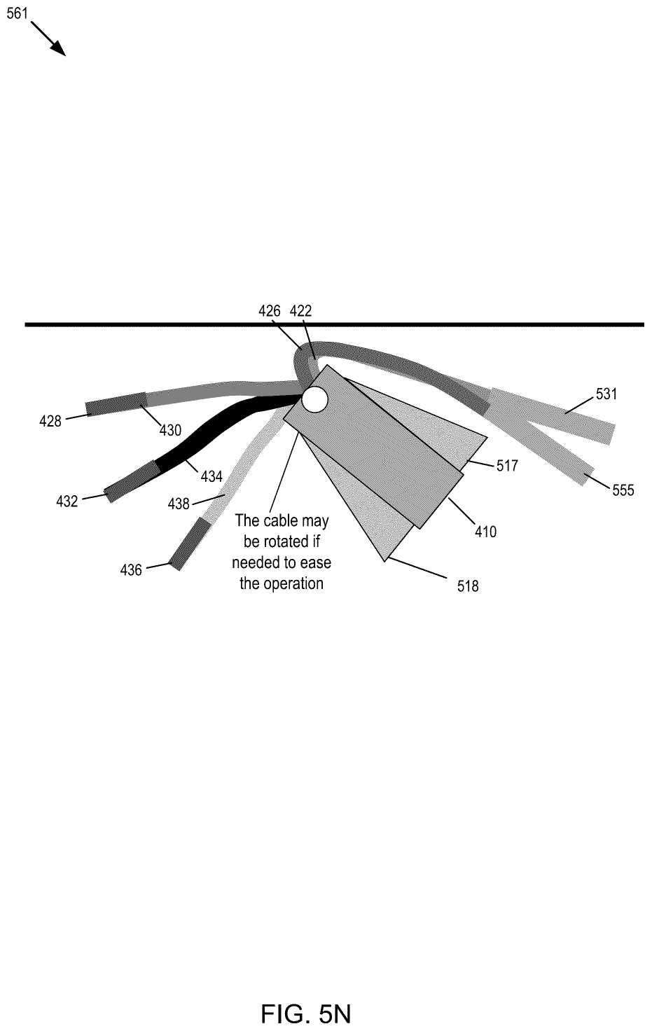

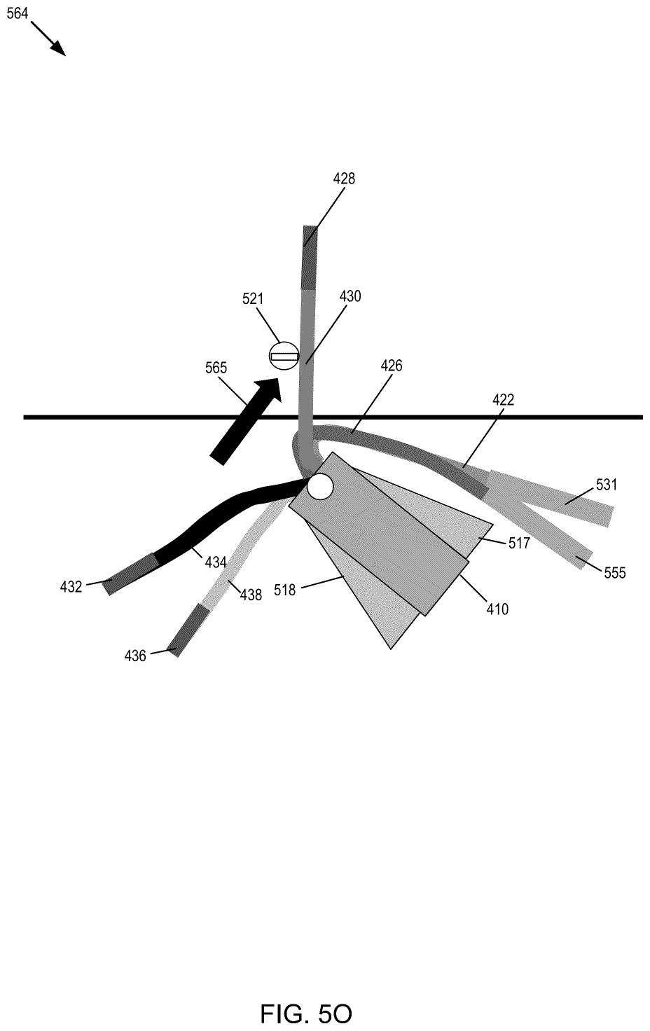

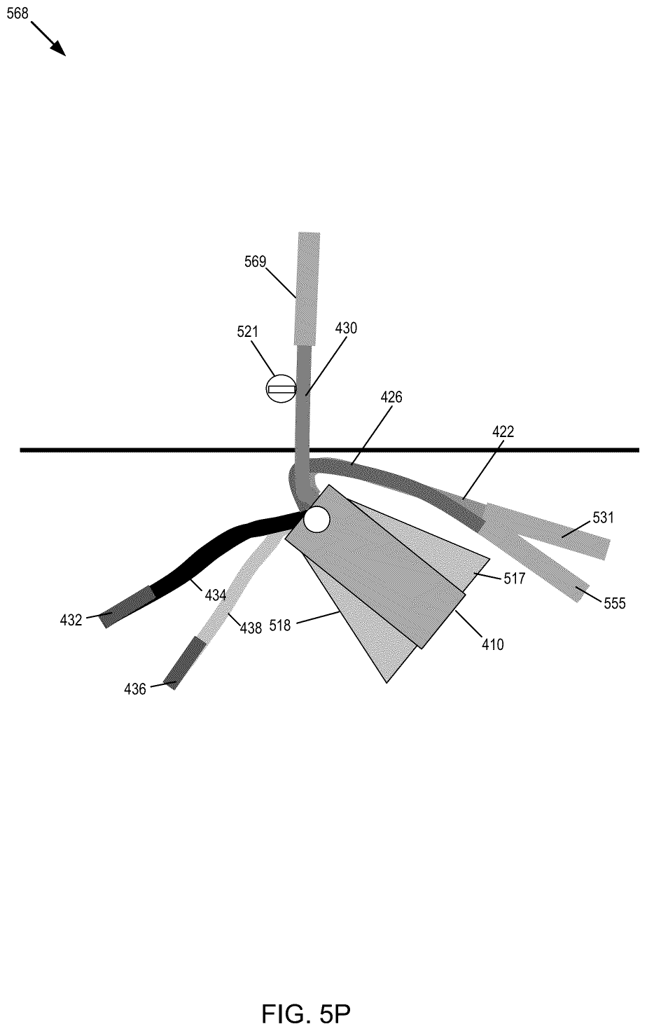

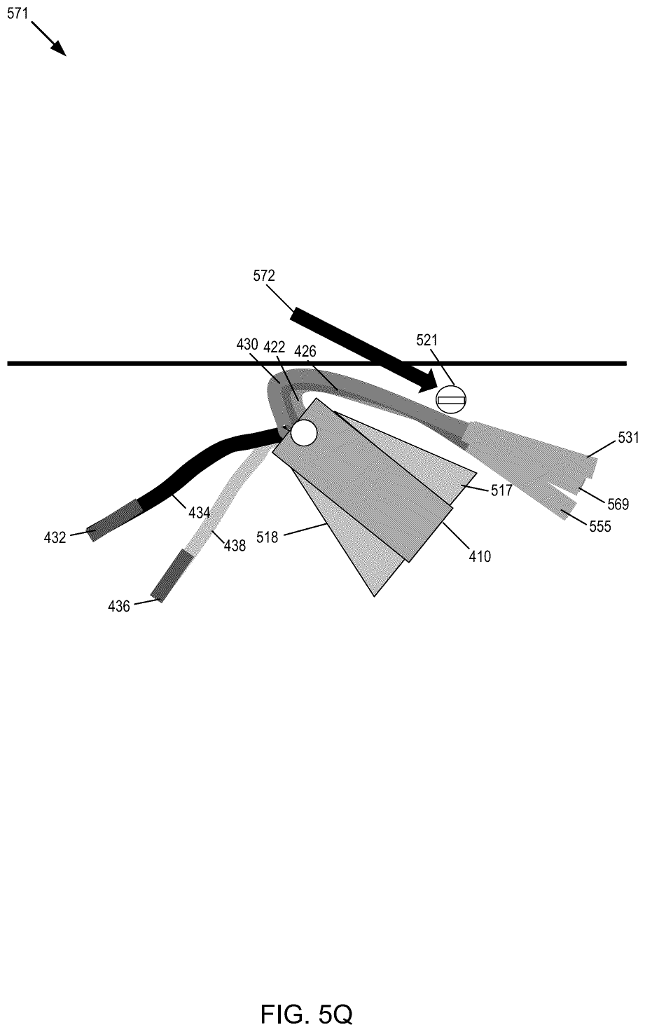

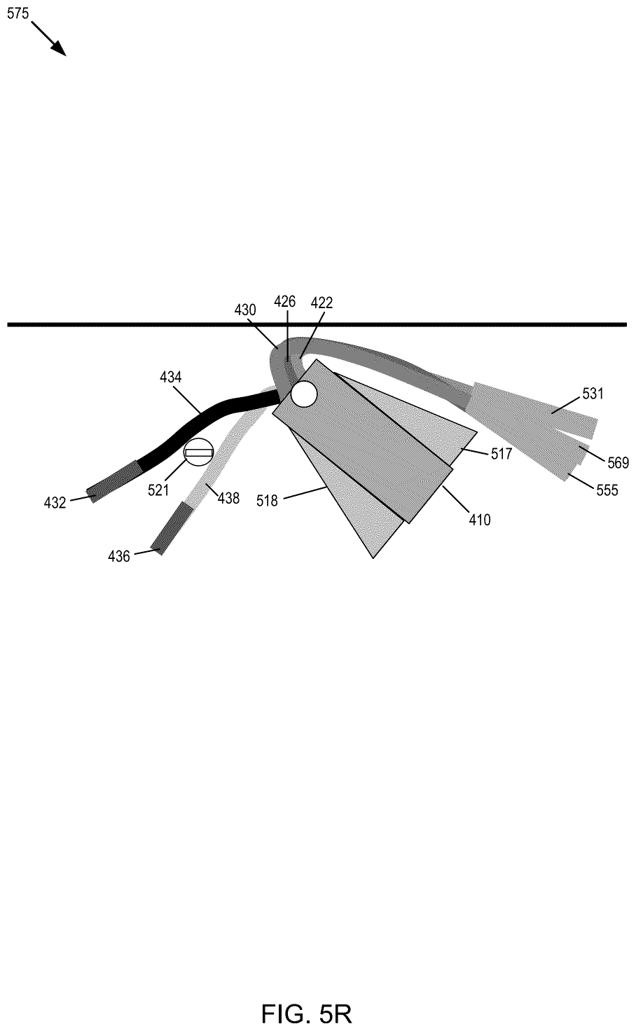

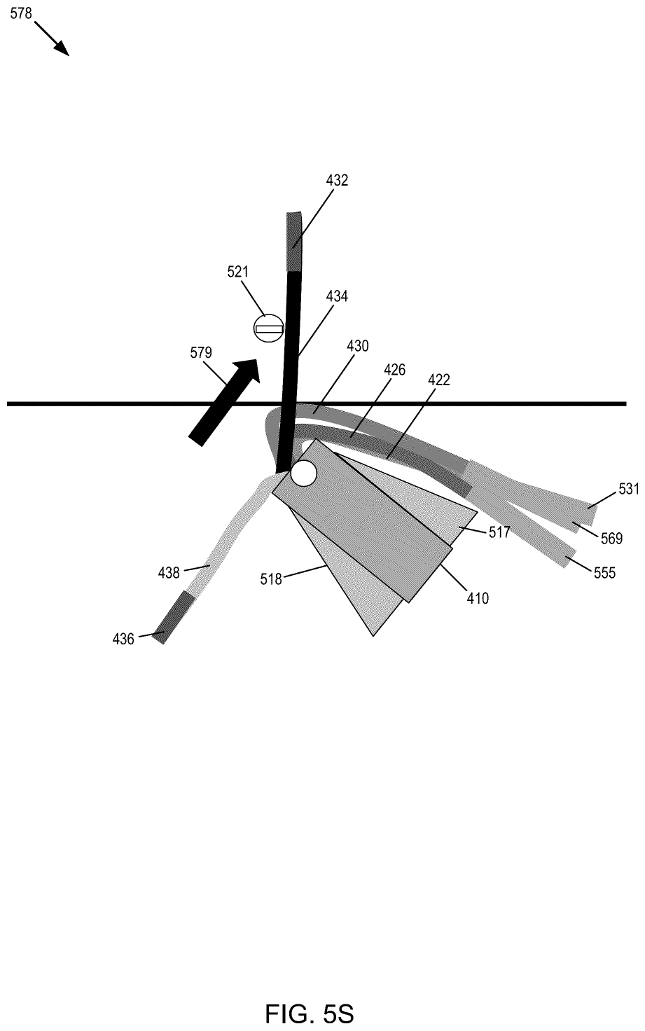

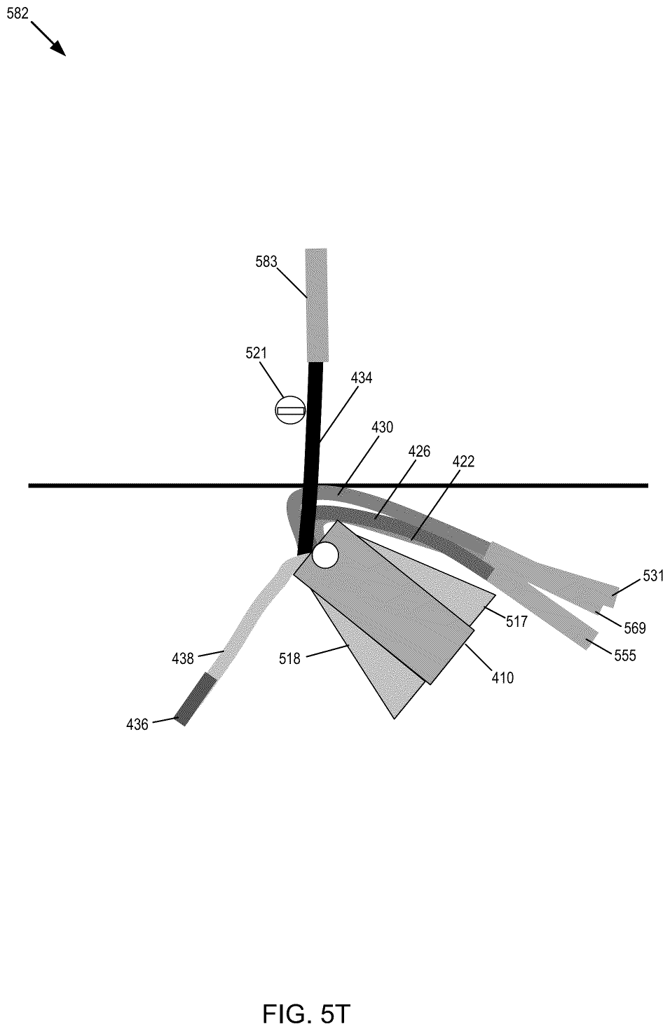

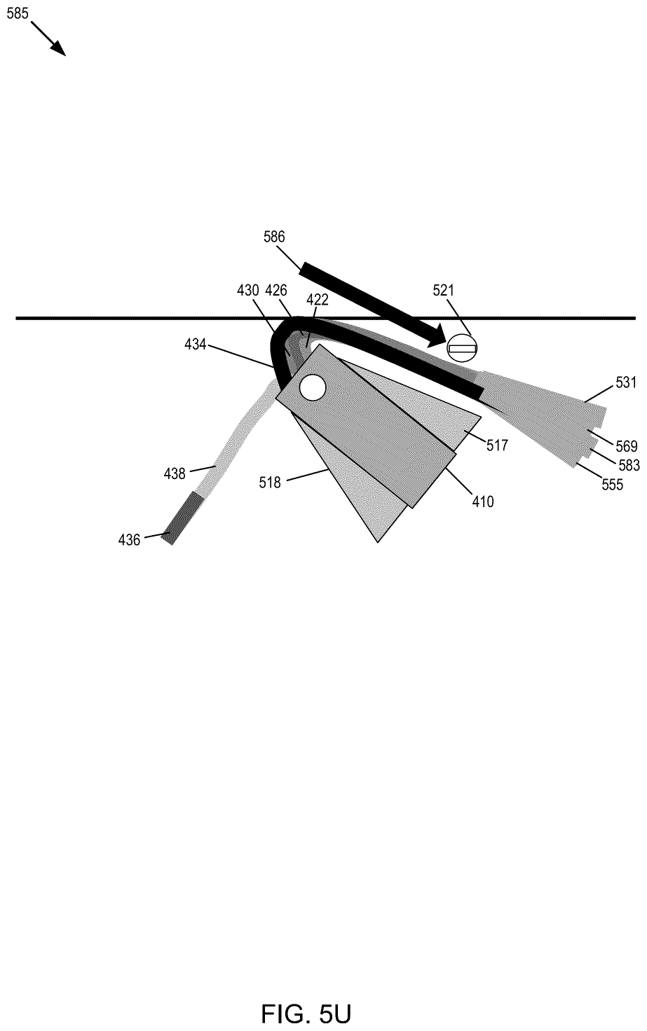

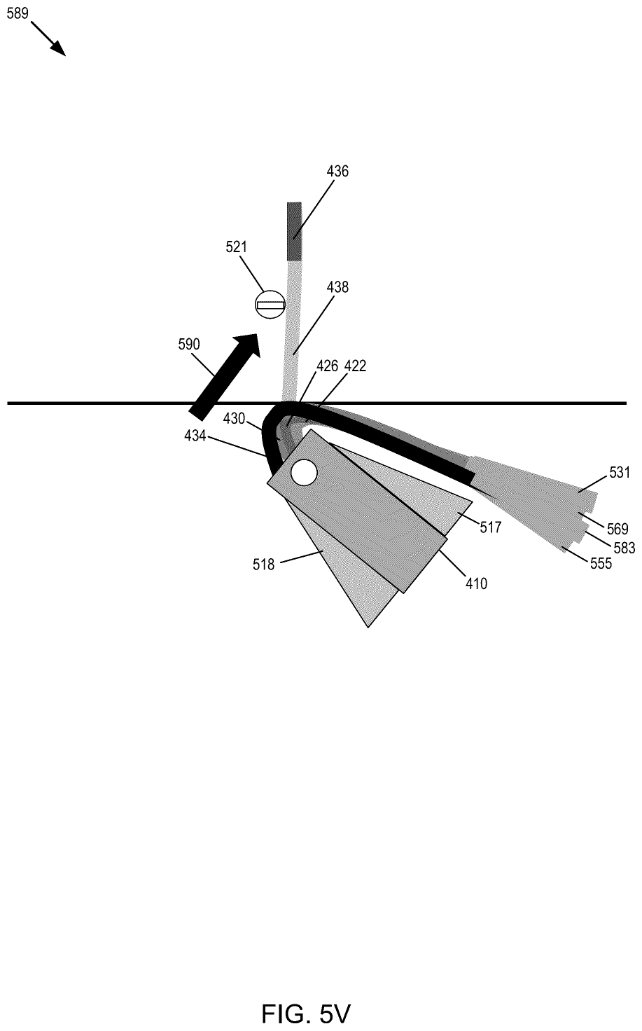

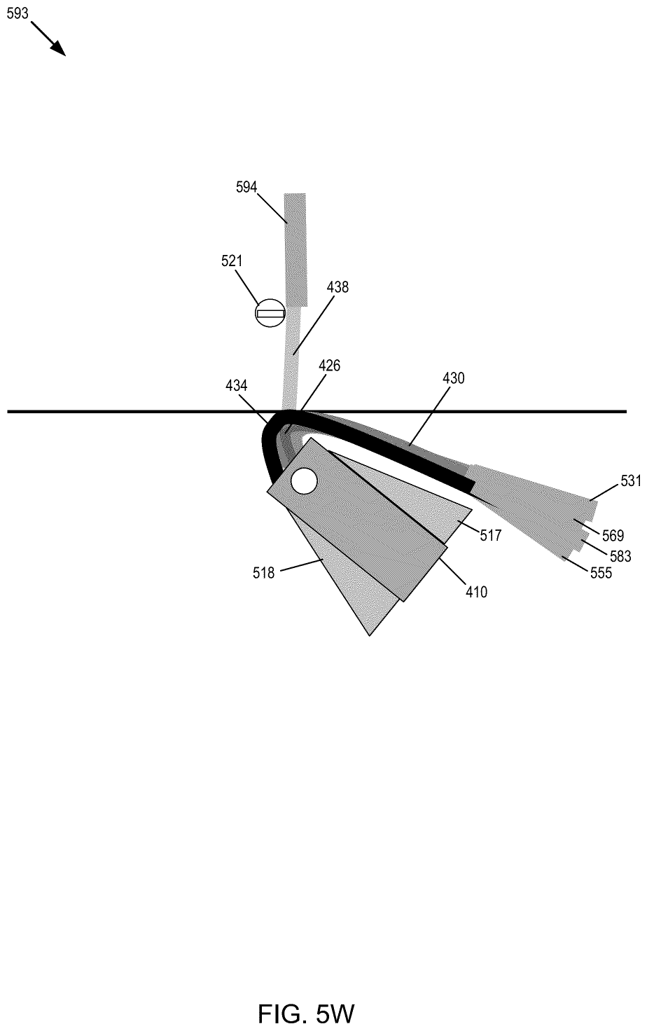

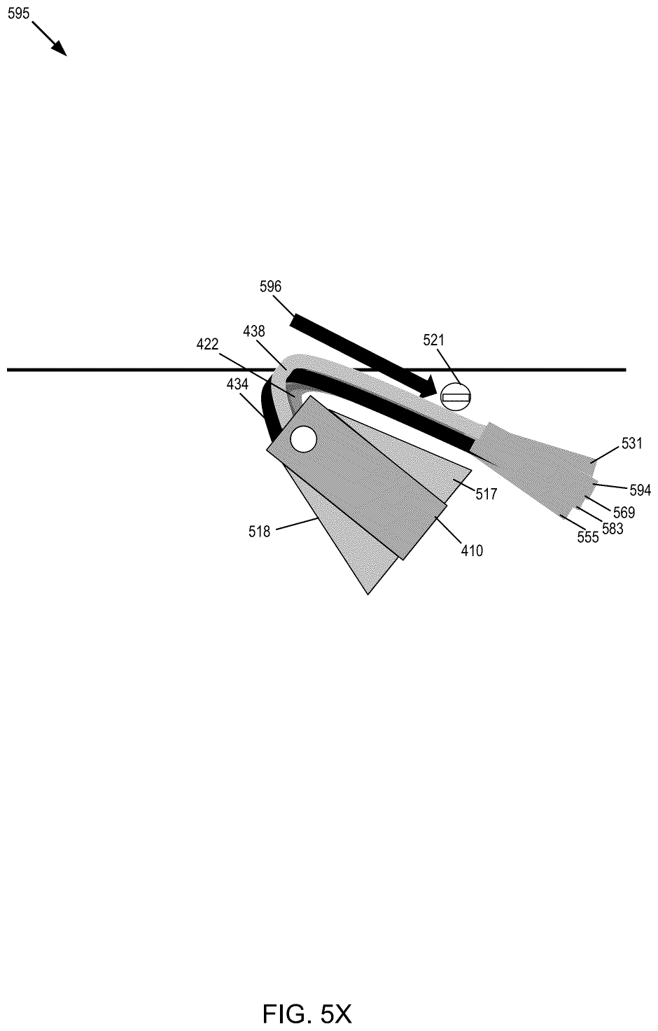

The communication interface 120 may comprise a wired and/or wired communication interface in order to communicate with the one or more other units (see FIG. 1A) and/or the central controller 112. The one or more motors 122 may comprise a force generator in order to move an object (e.g., a gripper and/or a pin-like device) and/or to impart a force (e.g., for use by the crimp anvil 142 and/or the crimp die 140 of the applicator 138; for use by gripper to impart movement such as rotational movement; for use by pin-like device to move wire(s)). Thus, in one or some embodiments, the one or more motors 122 may comprise one or more motors to move the wire(s) (see hardware for wire manipulation 134) and/or the cable (see hardware for cable manipulation 126) in any manner as discussed herein, as in known by one of skill in the art. As one example, the gripper (powered by the motor(s)) grip the multi-wire cable (such as shown in FIG. 2C or in FIG. 5C)) may move the wires in any one, any combination, or all of: the X-direction; the Y-direction; the Z-direction; or the theta direction (e.g., rotationally). In one or some embodiments, the movement by the gripper may result in movement of the wire(s) (such as the simultaneous movement of all of the wires) in one direction at a time. For example, the gripper may move the wire(s) (such as simultaneously all of the wires) first in the X-direction (e.g., to line up with the applicator in the X-direction), then in the theta direction (e.g., rotating so that the tip of the respective wire for insertion into the application points in the same direction as an axis of the chamber of the application into which the applicator is to be inserted so that the respective wire is aligned with the chamber), then in the Y-direction (in order to insert the respective wire into the chamber of the applicator), and then in the Z-direction (e.g., so that the wire is at a predetermined distance from the crimp contact, such as illustrated in FIG. 2F). Alternatively, the movement by the gripper may result in movement in more than one direction at a time. As one example, the gripper may move the wire(s) simultaneously in the Y-direction and in the Z-direction (e.g., such as illustrated in FIG. 2F in which the wire(s) may move in the Y-direction and the Z-direction simultaneously).

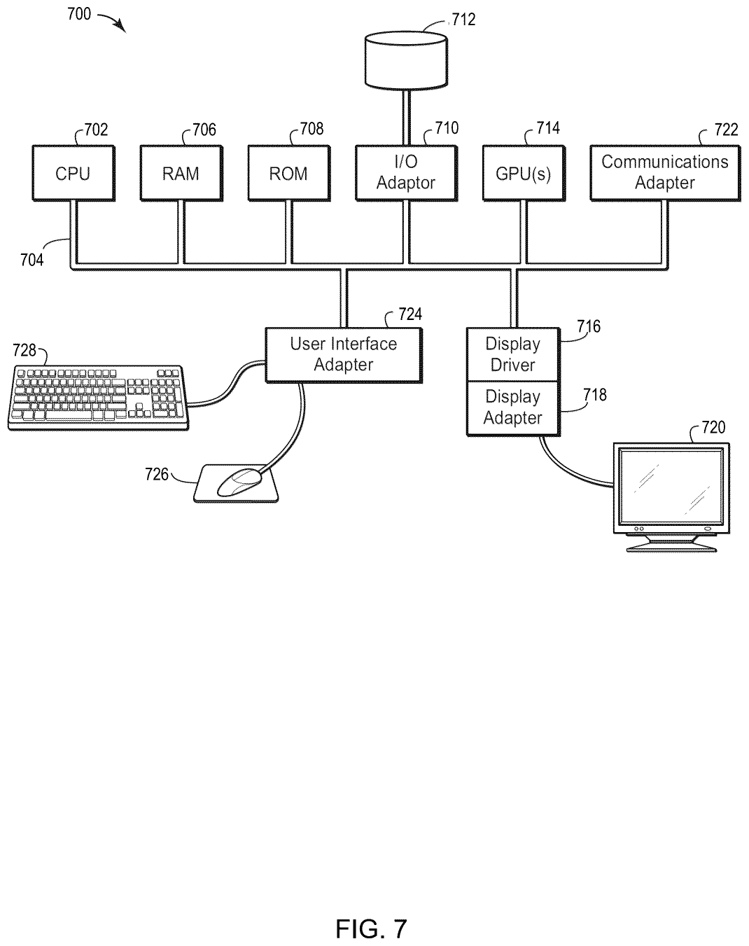

The illumination device 124 may comprise one or more lamps or other illumination sources in the visible and/or near visible spectra in order to illuminate one or more parts of the automated crimping machine 110. The hardware for cable manipulation 126 may comprise a gripper, vise or the like in order to contact, grab, and/or impart force on an object, such as the cable. The computational functionality 128 may comprise at least one processor 130 and at least one memory 132. In one or some embodiments, the computational functionality (e.g., the at least one processor) may be configured to generate one or more commands in order to control various parts of the system depicted in FIG. 1B. Merely by way of example, the at least one processor 130 may be configured to command hardware for wire manipulation 134 (e.g., the at least one processor 130 may send one or more commands to the one or more motors, which in turn may move a pin-like device, such as discussed herein) and/or command hardware for cable manipulation 126 (e.g., the at least one processor 130 may send one or more commands to the one or more motors, which in turn may control the gripper, such as discussed herein). As another example, the at least one processor 130 may command the illumination device, the operating panel to output status information and/or receive operator input, the crimp contact mechanicals to automatically spool the crimp contacts into the applicator chamber, the sensors to generate sensor data (e.g., one or more images), etc. Further, as discussed in more detail with regard to FIG. 7, the at least one memory 132 may store information and/or software, with the at least one processor 130 configured to execute the software stored in the at least one memory 132. In one or some embodiments, the at least one processor 130 may comprise a microprocessor, controller, PLA, or the like. The at least one memory 132 may comprise any type of storage device (e.g., any type of memory). Though the at least one processor 25 and the at least one memory 26 are depicted as separate elements, they may be part of a single machine, which includes a microprocessor (or other type of controller) and a memory. Alternatively, the at least one processor 130 may rely on the at least one memory 132 for all of its memory needs. The at least one processor 130 and at least one memory 132 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The hardware for wire manipulation 134 may comprise a pin, a pin-like device, or other types of devices as discussed herein. The operating panel 136 may comprise an input/output interface, such as a touchscreen, which may comprise a control panel through which an operator may enter command(s) and which may comprise an output device (e.g., a screen) which may indicate a state (e.g., a current status) of the automated crimping machine 110. The applicator 138 may comprise a crimp die 140 and a crimp anvil 142. In practice, the crimp die 140 may include one or more cutters. In one or some embodiments, the crimp anvil 142 may be positioned below the crimp die 140, with the crimp contact placed on the crimp anvil. After which, the wire is placed in predetermined relation to the crimp contact (see FIG. 2F). After which, the crimp die may move downward in order to crimp the crimp contact onto the wire. See US Patent Application Publication No. 2020/0366042 A1, US Patent Application Publication No. 2015/0074990 A1, both of which are incorporated by reference herein in their entirety. Further, as discussed herein, the crimp contact may initially be connected to a strip that may house or contain thousands of crimp contacts. After (or during) the crimp operation, the crimp contact may be disconnected from the strip (e.g., the cutter may cut the crimp contact from the strip) so that the crimp contact may be crimped to the wire and also be disconnected from the stip. Separately, remaining portions of the strip (e.g., after the crimp contact has been cut from the strip) may be periodically cut from the main body of the strip (e.g., the portion that still includes the strip connected to the crimp contacts). The cut of the remaining portions of the strip may be performed outside of the applicator, such as by a cutter that is separate from the crimp die.

In one or some embodiments, the sensor(s) 144 may comprise one or more cameras that may be used to perform machine vision. Alternatively, or in addition, the sensor(s) may comprise proximity sensor(s). The crimp contact mechanicals 146 may comprise the hardware for housing the crimp contacts (e.g., a roll of crimp contacts), for advancing the roll in order to insert a respective crimp contact into the applicator, and for disposing of refuse regarding the roll after the crimp contact has been used. For example, the crimp contacts may be stored, prior to crimping, in a reel or a spool where thousands of crimp contacts are connected to a mechanical strip. In practice, the reel or spool may be affixed to a part of the crimping machine in order to rotate. Further, in practice, the reel or spool may be automatically fed or spooled into the applicator (e.g., the reel is automatically spooled so that a single crimp contact may be placed within the chamber of the applicator for crimping; after crimping, the reel may be spooled again to introduce a single crimp contact into the chamber for crimping the next wire; and so on). In this way, the spooling of the crimp contacts into the chamber may, in one embodiment, be fully automated.

FIG. 1C is a second block diagram of the automated crimping machine 110 that integrates a robotic system 170 (e.g., an automatic robotic system) with an at least partially manually-operated crimping machine 150. By way of background, existing partially manual crimping machines may require the operator to perform one or more manual operations, such as any one, any combination, or all of: spreading the wires; separating a respective wire for insertion into the applicator; inserting the respective wire into the applicator; manually providing input commanding the partially manual crimping machine to perform the crimping; etc. See US Patent Application Publication No. 2015/0372437 A1, incorporated by reference herein in its entirety. As shown in FIG. 1C, the at least partially manually-operated crimping machine 150 may include any one, any combination, or all of: computational functionality 128, applicator 138; crimp contact mechanicals; communication interface 152; motor(s) 154; illumination device 156; operating panel 158; and sensor(s) 160. The communication interface 152 may communicate with robotic system 170 and/or with an external device. Motor(s) 154 may be configured to operate the applicator 138 as discussed here and operate the crimp contact mechanicals 146. Illumination device 156 may be configured to illuminate one or more areas of the at least partially manually-operated crimping machine 150. Operating panel 158 may comprise an input/output interface, such as a touchscreen, which may comprise a control panel through which an operator may enter command(s), such as to activate the partially manual crimping machine to perform the crimping, and which may comprise an output device (e.g., a screen) which may indicate a state (e.g., a current status) of the at least partially manually-operated crimping machine 150. Sensor(s) 160 may comprise any device used to sense at least one aspect of the at least partially manually-operated crimping machine 150.

In one or some embodiments, the robotic system 170 may be configured to automatically perform any one, any combination, or all of the manual operations that previously were performed by the at least partially manually-operated crimping machine 150. As one example, the robotic system 170 may automatically perform any one, any combination, or all of: automatically spreading the wires; automatically separating a respective wire for insertion into the applicator; automatically inserting the respective wire into the applicator; or automatically providing input commanding the partially manual crimping machine to perform the crimping. In this regard, the robotic system may work in combination with the at least partially manually-operated crimping machine 150, effectively becoming an automatic version of the operator and interfacing with the at least partially manually-operated crimping machine 150, so that the combination of the at least partially manually-operated crimping machine 150 and the robotic system 170 may comprise the automated crimping machine 110.

Merely as one example, the robotic system 170 may automatically feed the respective wire into the applicator 138 of the at least partially manually-operated crimping machine 150 and then send a command (akin to the operator providing manual input to command the partially manual crimping machine to perform the crimping) to the at least partially manually-operated crimping machine 150 to perform the crimp operation. In this regard, the at least partially manually-operated crimping machine 150 may maintain its basic operational functions, seemingly still relying on manual input (e.g., insertion of the respective wire and providing input to command activation of the crimp operation); however, the robotic system 170 may mimic the manual operations, effectively rendering the combined system into the automated crimping machine 110.

The at least partially manually-operated crimping machine 150 and the robotic system 170 may be housed within a single housing 180, positioned such that the interaction(s) (e.g., the insertion by the robotic system of the wire into the applicator of the at least partially manually-operated crimping machine 150) may properly occur. Alternatively, the at least partially manually-operated crimping machine 150 and the robotic system 170 may be housed in separate housings with the at least partially manually-operated crimping machine 150 and the robotic system 170 likewise being positioned such the interaction(s) may properly occur.

Alternatively, the robotic system 170 may work in combination with a fully automated crimping machine.

FIG. 2A is a top view 200 of the cable 212 stripped of one or more protective layers to expose the multiple wires 202, 204, 206, 208, 210 therein. It is noted that a wire may be crimped after its end has been stripped from isolation or without stripping the isolation (e.g., in such a case of not stripping the isolation, the crimp contact may penetrate the isolation layer in order to reach the underlying conductive portion therein. In this regard, any discussion or any illustration of a wire being stripped at its end of isolation in preparation for crimping may likewise be applicable to crimping without the isolation layer being removed prior to crimping.

Further, FIG. 2A illustrates 5 wires. This is merely shown for purposes of example. Other numbers of wires are contemplated, such as less than 5 wires (e.g., 2 wires, 3 wires or 4 wires) or greater than 5 wires (e.g., 6 wires, 7 wires, 8 wires, 9 wires, 10 wires, 15 wires, 20 wires, 25 wires, 30 wires, or more).

FIG. 2B is a top view 214 of the cable 212 with the exposed multiple wires 202, 204, 206, 208, 210 spread apart. The multiple wires 202, 204, 206, 208, 210 may be spread apart in one of several ways. In one way, the multiple wires 202, 204, 206, 208, 210 may first be flattened, followed by separation. Flattening may occur, for example, by pressing a flat weights or the like on top of the multiple wires 202, 204, 206, 208, 210 at least partly while moving the cable (e.g., moving the cable backward, or forward and backward). After the flattening, the multiple wires 202, 204, 206, 208, 210 may be separated, such as by using a claw-type device, a pin-like device, or the like to separate the wires. As discussed in more detail below, the separated wires may have a predetermined distance between them (e.g., the ends of the wires may be at least a predetermined distance to its nearest neighbor wire(s) and or may have at least a predetermined angle that is formed by the different wires.

FIG. 2C is a top view 218 of the cable 212 rotated about theta (θ) 219. As discussed above, one option for positioning the wires and/or the cable may be to rotate the cable, such as rotating about θ 219. Further, as discussed above, the machine vision, which may be embodied in computational functionality 128 using sensor(s) 144, may determine whether and/or when to perform various actions, such as rotation of the cable. Thus, in one or some embodiments, responsive to the machine vision determining the rotate the cable, a gripper 220 (or the like) which grips an outer surface of the cable 212 may rotate the cable about a rotational axis in order to position one or more wires or position the cable. As shown in FIG. 1C, the rotation may position wire 202 so that it is pointing upward (toward 12:00) in preparation for inserting wire 202 into the applicator 138.

FIG. 2C further illustrates line 221, which indicates a direction of end of wire 202. In preparation for insertion into the applicator 138, the machine vision may analyze a direction of the end of the respective wire for insertion therein. The determined direction may then be compared with the direction of the chamber within the applicator 138 into which the respective wire will be inserted. The machine vision may determine whether the directions of the end of the wire and the chamber are in alignment (e.g., within a predetermined tolerance). If not, in one or some embodiments, the cable may be rotated either clockwise or counter-clockwise in order to modify the direction of the end of the wire so that it is in alignment with the chamber. Alternatively, the wire may be moved individually, such as by the pin 225 illustrated in FIG. 2D, in order to bring the wire into alignment.

FIG. 2D is a top view 224 of the cable 212 with a nearest wire (see wire 204) (to the respective wire for crimping, see wire 202) being individually manipulated in a rotational direction. In particular, pin-like device 225 may be moved to contact wire 204 and impart a force in order to move wire 204 in a rotational direction (see 226). In this way, wire 204 may be brought further away from wire 202 (with the resultant angle therebetween being increased) and closer to wire 206 (with the resultant angle therebetween being decreased). The movement of wire 204 illustrated in FIG. 2D may be in preparation of insertion of wire 202, as illustrated in FIG. 2E. In this way, the wires may be moved rotationally in one of several ways, such as by rotating the cable so that all of the wires simultaneously move rotationally and/or such as by rotating individual wires (see FIG. 2D).

FIG. 2E is a top view 227 of the cable 212 with a nearest wire (see wire 204, after one or more manipulations) being at least a predetermined distance (see 230) from at least a part of the applicator 228. In particular, wire 202 has been moved (such as by gripper 220) in the Y-direction (and optionally in the X-direction) in order to insert the wire 202 into chamber 229 of applicator 228. Because of the previous movements of the cable (e.g., rotationally) and/or previous movements of the individual wire(s) (e.g., wire 204 in FIG. 2D), when wire 202 is inserted into applicator 228, the nearest wire (see wire 204) is at least a predetermined distance away from a part of the applicator 228 (e.g., a closest edge of the applicator (see 230); an opening of the applicator into which wire 202 is inserted; etc.). In this way, wire 202 may be automatically inserted into applicator 228 without an adjacent wire (e.g., wire 204) contacting applicator 228.

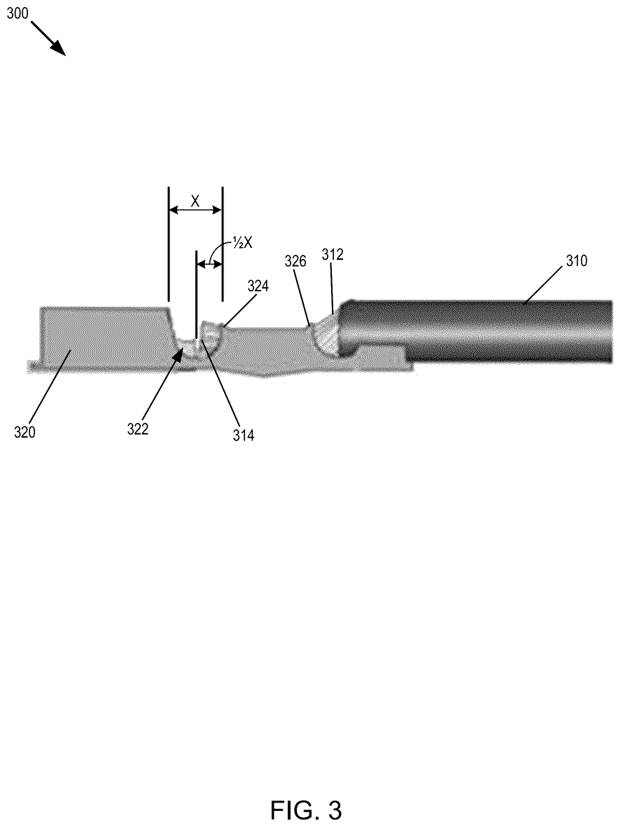

FIG. 2F is a side view 231 of the wire in order to position the conductive portion 234 and the insulated portion 232 of the wire in a predetermined position relative to the crimp contact 246 in one or both of the Y direction or the Z direction. For background, the wire may include the conductive portion 234, which may comprise a metal or other type of electrically conductive material. The conductive portion 234 may be covered by an insulated portion, such as plastic, rubber-like polymers, or other material that is non-conductive. In one or some embodiments, machine vision may be used in order to place the conductive portion 234 and/or the insulated portion 232 of the wire in a predetermined position (in either or both of the Y-direction or the Z-direction) relative to the crimp contact 246. In this way, the conductive portion 234 and the insulated portion 232 of the wire may be crimped within the crimp contact 246 such as illustrated in FIG. 3, discussed further below.

In order to determine placement of the conductive portion 234 and the insulated portion 232 relative to the crimp contact 246, machine vision may be used. In particular, machine vision may use one or more cameras in order to determine the placement of one or more objects, such as the wire(s) 202, 204, 206, 208, 210, the applicator 228, the crimp contact 246, etc., as discussed above. In one embodiment, a single camera is used. Alternatively, multiple cameras may be used. For example, a first camera may capture a top view (such as illustrated in FIGS. 2A-E) and a second camera may capture a side view (such as illustrated in FIG. 2F). The second camera may determine the placement of the conductive portion 234 and the insulated portion 232 relative to the crimp contact 246. In one or some embodiments, the first camera with the top view and the second camera with the side view may both provide position information in order to modify positioning in the Y-direction.

In one or some embodiments, an edge of the conductive portion 234 may be placed halfway (shown as line 238) within crevice 242 and may be placed to overlap an edge (shown as line 240) of indent 244. Responsive to machine vision determining that the placement of conductive portion 234 is misaligned, the wire may be moved in the Y-direction in order to move the edge of conductive portion closer to line 238 and so that the conductive portion overlaps the edge of indent 244.

Alternatively, or in addition, the wire may be moved in the Z-direction in order to position the wire at a predetermined distance from the crimp contact 246. This is illustrated in FIG. 2F in which 236 is illustrated as the predetermined distance. In one or some embodiments, the predetermined distance comprises a predetermined non-zero distance (e.g., the wire is no greater than the predetermined non-zero distance to the crimp contact; the wire is in a non-zero range from the crimp contact, such as no greater than a first predetermined non-zero distance to the crimp contact and no less than a second predetermined non-zero distance to the crimp contact). Alternatively, the predetermined distance comprises a zero distance. In one or some embodiments, if the conductive portion 234 is too far from the crimp contact 246, the conductive portion 234 may bend in the crimping process, thereby misaligning the wire within the crimp contact 246. As such, the wire (including the conductive portion 234) may be positioned at the predetermined distance for proper crimping. In this regard, machine vision may determine the distance of the conductive portion 234 from the crimp contact. Responsive to determining the distance is within tolerance, the machine vision may determine not to modify the position of the wire (including the conductive portion 234) in the Z-direction. Responsive to determining the distance is not within tolerance, the machine vision may determine to modify the position of the wire (including the conductive portion 234) in the Z-direction to be closer to (e.g., within tolerance of) the predetermined distance 236.

FIG. 3 is a side view 300 of the wire of the cable after having been crimped with the crimp contact 320. The wire includes a conductive portion 312 and an insulated portion 310. Crimp contact includes a crevice 322 and edges 324, 326, with FIG. 3 illustrating a recommended positioning of the conductive portion 312 within crimp contact 320 after crimping. As one example, edge 314 of conductive portion 312 is positioned 1/2 in crevice 322. Further, conductive portion 312 touches both edges 324, 326. As discussed above, the proper positioning prior to crimping of wire (e.g., in the Y-direction and/or in the Z-direction) may result in the proper positioning of the conductive portion 312 after crimping.

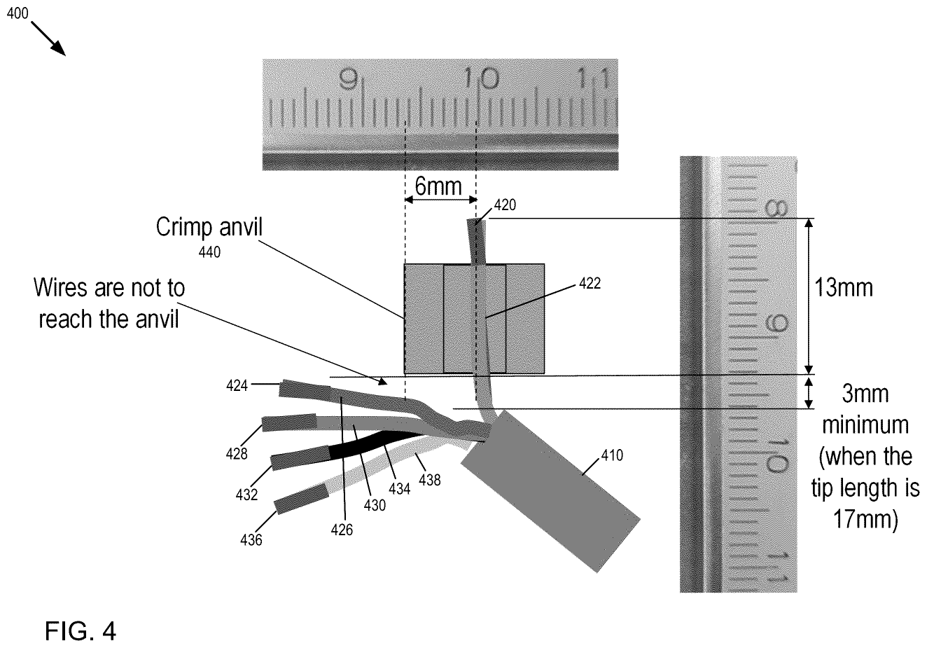

FIG. 4 illustrates one example environment 400 for the cable with multiple wires 422, 426, 430, 434, 438 in which one wire 422 is inserted within the crimp anvil 440 of the applicator. As shown in FIG. 4, each wire 422, 426, 430, 434, 438 includes a conductive portion 420, 424, 428, 432, 436, with a main portion 410 of the cable. Further, FIG. 4 illustrates various dimensions as an example illustration of the small dimensions (e.g., less than 10 mm). For example, wire 426 is to be at least a predetermined distance from crimp anvil 440, as discussed above.

FIGS. 5A-X illustrate an example series of manipulations of one or both of the wire(s) or the cable. In particular, FIG. 5A is an illustration 500 of another example of the wires 422, 426, 430, 434, 438 of the cable prior to being spread out. FIG. 5B is an illustration 506 of the wires 422, 426, 430, 434, 438 of the cable in FIG. 5A after having been spread out. As shown, the wires 422, 426, 430, 434, 438 may be spread such that angles 507, 508, 509, 510 are formed. In one or some embodiments, the angles 507, 508, 509, 510 may be at least greater than a predetermined amount.

As discussed above, the cable may be rotated at different times in the process responsive to a machine vision determination. FIG. 5C is an illustration 514 of the rotating of the cable about a rotation axis 516. The rotation may be in a rotation direction 515 and may be performed by a gripper 517, 518 holding a portion of cable 410. Further, FIG. 5C illustrates a length of wire 422 needed for the crimping machine (e.g., when inserted within the applicator).

FIG. 5D is an illustration 520 of insertion of a pin-like device 521 in between two of the wires (see 422, 426) of the cable. As shown in FIG. 5D, the spacing between some or all of the wires in the cable may be maintained due to the rigidity of the wires. FIG. 5E is an illustration 525 of one wire (see 426) being moved axially by the pin-like device 521 moving in direction 526. This movement of wire 426 may be in preparation of insertion of wire 422 into the applicator so that wire 526 does not touch or interfere with the applicator when crimping wire 522. FIG. 5F is an illustration 530 of a respective wire 422 being inserted in direction 532 into crimp anvil 440 of the applicator. After which, crimp contact 531 is attached to wire 422. Further, wire 426 is shown to be distance 533 from crimp anvil 440 of the applicator. FIG. 5G is an illustration 535 of, after crimping the crimp contact 531 onto a first respective wire 422, withdrawing the wire 422 in direction 536 from the applicator. After withdrawing the wire 422, FIG. 5H is an illustration 538 of the pin-like device 521 being moved in direction 539 to be adjacent to the first respective wire 422. FIG. 5I is an illustration 542 of the pin-like device 521 moving in a direction 543 so that the first respective wire 422 is further away from its nearest adjacent wire (e.g., the second respective wire 426).

FIG. 5J is an illustration 546 of the pin-like device 521 being moved to be adjacent to the second respective wire 426 for crimping. FIG. 5K is an illustration 500 of the pin-like device 521 moving in a direction 551 so that the second respective wire 426 is moved in preparation for insertion into the applicator. FIG. 5L is an illustration 554 of the second respective wire 526 after having a crimp contact 555 crimped thereto and after removing the second respective wire from the applicator. FIG. 5M is an illustration 557 of the pin-like device 521 moving in a direction 558 so that the second respective wire 426 is further away from the third respective wire 430 and closer to the first respective wire 422.

As discussed above, machine vision may periodically determine to rotate cable. This is illustrated in FIG. 5N, which is an illustration 561 of the cable being rotated responsive to machine vision analysis. For example, in one or some embodiments, machine vision may analyze the positioning to determine whether to rotate the cable. In one particular embodiment, machine vision may analyze positioning after one, some or each wire is crimped. Alternatively, machine vision may analyze positioning after a certain number of wires are crimped (e.g., after 2 of 5 wires are crimped).

The rotation may thus better position the remaining wires for crimping. After which, FIG. 5O is an illustration 564 of the pin-like device 521 moving in a direction 565 so that the third respective wire 430 is prepared for insertion into the applicator. FIG. 5P is an illustration 568 of the third respective wire 430 after having a crimp contact 569 crimped thereto and after removing the third respective wire 430 from the applicator. FIG. 5Q is an illustration 571 of the pin-like device 521 moving in a direction 572 so that the third respective wire 430 to be further away from the fourth respective wire 434 and closer to the first respective wire 422 and the second respective wire 426.

FIG. 5R is an illustration 575 of the pin-like device 521 being moved to be adjacent to the fourth respective wire 434. FIG. 5S is an illustration 578 of the pin-like device 521 moving in direction 579 so that the fourth respective wire 434 is prepared for insertion into the applicator.

FIG. 5T is an illustration 582 of the fourth respective wire 434 after having a crimp contact 583 crimped thereto and after removing the fourth respective wire 434 from the applicator. FIG. 5U is an illustration 585 of the pin-like device 521 moving in direction 586 so that the fourth respective wire 434 is further away from the fifth respective wire 438 and closer to the first respective wire 422, the second respective wire 426, and the third respective wire 430. FIG. 5V is an illustration 589 of the pin-like device 521 moving the fifth respective wire 438 in preparation for insertion into the applicator. FIG. 5W is an illustration 593 of the fifth respective wire 438 after having a crimp contact 594 crimped thereto and after removing the fifth respective wire 438 from the applicator. FIG. 5X is an illustration 595 of the pin-like device 521 moving in direction 596 so that the fifth respective wire 438 is closer to the first respective wire 422, the second respective wire 426, the third respective wire 430, and the fourth respective wire 434.

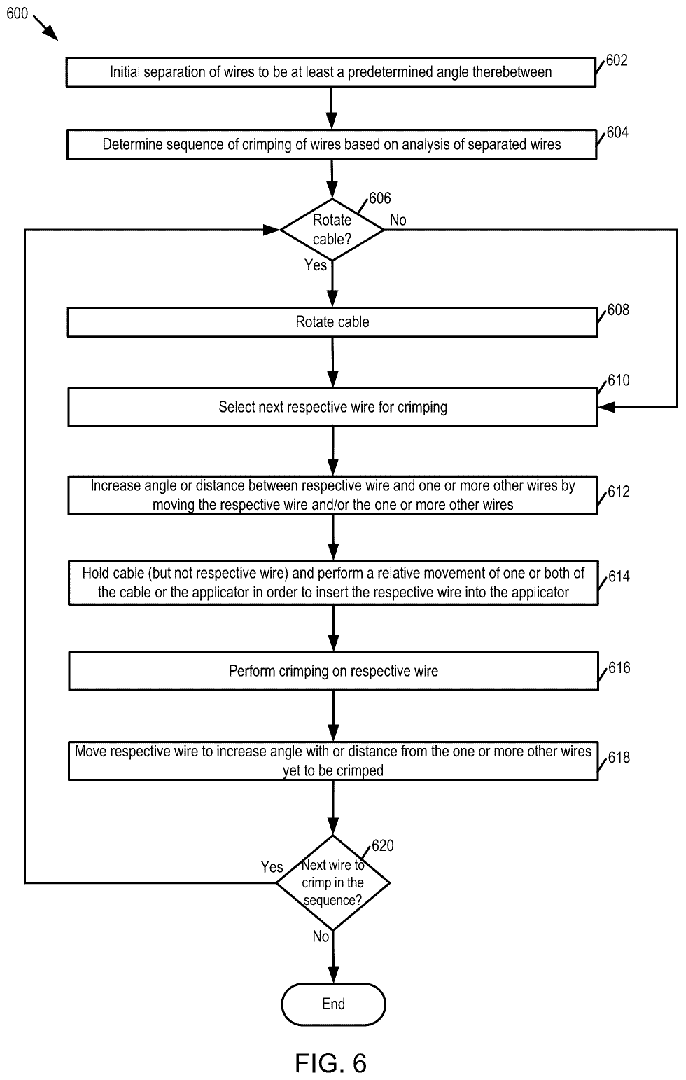

FIG. 6 illustrates an example flow chart 600 of one embodiment of the method. At 602, the wires of the cable are initially separated (e.g., to be at least a predetermined angle therebetween). This is illustrated, for example, in FIG. 5B. In one or some embodiments, the separation of the wires may be performed by a machine that is separate from the automatic crimping machine (see FIGS. 1A-C) or a robotic system (see FIG. 1C). For example, the machine configured to separate the wires may be in a machine that is one of the plurality machines as part of the production line. Alternatively, the separation of the wires may be performed by the automatic crimping machine (see FIGS. 1A-C) or the robotic system (see FIG. 1C).

Further, as discussed above, the system (whether the automatic crimping machine or the robotic system) may determine a sequence of the wires for crimping at 604. The sequence may be determined in one of several ways. In one way, the sequence may be determined solely based on analysis of the spread or separation of the wires in 602. In particular, the spreading of the wires may not result in a predetermined positioning of the wires (e.g., the blue wire may not always be spread out to be on the far left, as depicted in FIG. 2B). Rather, in one or some embodiments, the system may dynamically determine the sequence based on the spreading. For the example depicted in FIG. 2B, after the spreading of the wires, the wires may be positioned, from right to left, in a sequence of 202, 204, 206, 208, 210. The system may then access a predetermined sequence. The predetermined sequence may be from right to left. Alternatively, the predetermined sequence may be from left to right. Still alternatively, the predetermined sequence may start with a wire that is not at an end (such as in the middle). In the example given in FIG. 2B, once the wires are identified from right to left as 202, 204, 206, 208, 210 and the predetermined sequence is right to left, the system may first select wire 202 for crimping, then wire 204 for crimping, then wire 206 for crimping, then wire 208 for crimping, and finally wire 210 for crimping. Alternatively, once the wires are identified from right to left as 202, 204, 206, 208, 210 and the predetermined sequence is left to right, the system may first select wire 210 for crimping, then wire 208 for crimping, then wire 206 for crimping, then wire 204 for crimping, and finally wire 202 for crimping.

In another way, the sequence may be determined based on analysis of the spread or separation of the wires and based on one or more aspects of the wires. For example, the one or more aspects of the wires may comprise any one, any combination, or all of the thickness of the wire, the color of the wire, the type of wire, the markings on the wire or the like. In particular, in one or some embodiments, all of the wires within a multi-wire cable may be of the same type and/or the same thickness so that all of the wires in the multi-wire cable are crimped using the same type of crimp contact. In such an instance, the sequence of the wires may be dictated solely by the spread (such as discussed above). However, in the instance where the multi-wire cable has different types of wires, so that different types of crimp contacts are used for the different types of wires in the cable, the sequence of crimping may be determined based on the spread and based on the type of wires (e.g., one or more wires in the multi-wire cable are of a first type (with a smaller thickness) for crimping to a smaller thickness crimp contact and other wires in the multi-wire cable are of a second type (with a larger thickness) for crimping to a larger thickness crimp contact). Thus, the wires of the first type may be crimped first and the wire(s) of the second type may be crimped after all of the wire(s) of the first type are crimped. In one embodiment, the crimping of the wires of the first type and the wires of the second type may be performed on the same crimping machine (e.g., ensuring that the crimping of the wires of the first type are with a first type of crimp contact and that the crimping of the wires of the second type are with a second type of crimp contact). Alternatively, the crimping of the wires of the first type may be performed on a first crimping machine and the wires of the second type may be performed on a second (and separate) crimping machine.

For purposes of discussion, the example depicted in FIG. 2B may have wires 202, 204, and 210 be of the first type and wires 206 and 208 be of the second type. In such an instance, after spread, machine vision may determine that wires 202, 204, and 210 are of the first type and wires 206 and 208 are of the second type. Further, the system may generate two sequences: a first sequence for the first type of wires and a second sequence for the second type of wires. The system may also access the predetermined sequence or predetermined ordering (e.g., whether right-to-left or left-to-right). In the event predetermined sequence or the predetermined ordering is right-to-left, the first sequence for the first type of wires is 202, 204, 210 and the second sequence for the second type of wires is 206 and 208. Alternatively, the second type of wires may be crimped first and then the first type of wires may be crimped. In such an instance and in which the predetermined sequence is right-to-left, the first sequence is for the second type of wires 206 and 208 and the second sequence is for the first type of wires 202, 204, 210. Still alternatively, the sequence may begin with a middle wire (e.g., a wire that is not on the end or a wire that is therebetween two wires on each end). In such an instance, any one of the middle wires may be selected for crimping first, after which other wires (whether in the middle or at an end) may be selected. In this regard, the system may determine the sequence either in a predetermined manner or in a dynamic manner.

At 606, it is determined whether to rotate the cable. If so, at 608, the cable is rotated (e.g., such as a predetermined amount of rotation). If not, flow chart 600 moves to 610, which selects a next respective wire for crimping. At 612, the angle or distance between the respective wire and one or more other wires are increased, such as by moving one or both of the respective wire or the one or more other wires. In this way the respective wire may be positioned for insertion into the applicator. At 614, while holding the cable (but not the respective wire), the respective wire is inserted into the applicator (e.g., such as by performing a relative movement of one or both of the cable or the applicator). After which, at 616, crimping is performed on the respective wire. In preparation for the next wire for crimping, at 618, the respective wire may then be moved to increase the angle with or the distance from the one or more other wires yet to be crimped. Typically, the wire, after being crimped, is larger and thus more likely to get in the way of crimping other wires in the multi-wire cable. As such, the crimped wire may be moved to one side or to the other. For example, if the sequence is from right-to-left (such as depicted in FIGS. 5A-X), after a wire is crimped, the crimped wire is moved further to the right (e.g., further enough so that it touches at least one other wire that has already been crimped). Similarly, if the sequence is from left-to-right, after a wire is crimped, the crimped wire is moved further to the left (e.g., further enough so that it touches at least one other wire that has already been crimped). In addition, in the even that different types of wires (with different types of crimped contacts) are being crimped, moving the crimped wires all the way to the left or to the right may be insufficient. In the example given above where wires 202, 204, and 210 are of the first type and wires 206 and 208 are of the second type, and where the wires of the first type are crimped first in the following sequence: 202, 204, 210, after crimping wire 202, the wire may be moved to the right, after crimping wire 204, the wire may also be moved to the right; however, after crimping wire 210, the wire may be moved to the left so that it does not interfere with crimping of wires 206 and 208. In this regard, after crimping, in one embodiment, each of the crimped wires are moved to a same side. Alternatively, crimped wires in the same multi-wire cable may be moved to different sides (particularly where there are wires in between the crimped wires that still need to be crimped. Alternatively, in the example given above where wires 202, 204, and 210 are of the first type and wires 206 and 208 are of the second type, and where the wires of the second type are crimped first in the following sequence: 206 and 208, after crimping wire 206, the wire 206 may be moved not to the right and not to the left, but upward (e.g., out of the screen as depicted in FIG. 2B) or downward (e.g., into the screen as depicted in FIG. 2B). Similarly, after crimping wire 208, the wire may be moved upward (such as bent 90° out of the screen) or downward (such as bent 90° into the screen). In this way, wires 206 and 208 may be bent to be outside of the plane where wires 202, 204, 210 reside. As such, after crimping wires 206 and 208, they may be moved sufficiently out of the way of later crimping of wires 202, 204, 210. At 620, it is determined whether there is another wire in the sequence for crimping. If so, flow chart 600 loops back to 606. If not, flow chart 600 ends.

In all practical applications, the present technological advancement must be used in conjunction with a computer, programmed in accordance with the disclosures herein. For example, FIG. 7 is a block diagram of an exemplary computer system that may be utilized to implement the methods described herein, including implementing the crimping machine illustrated in FIG. 1B. A central processing unit (CPU) 702 is coupled to system bus 704. The CPU 702 may be any general-purpose CPU, although other types of architectures of CPU 702 (or other components of exemplary computer system 700) may be used as long as CPU 702 (and other components of computer system 700) supports the operations as described herein. Those of ordinary skill in the art will appreciate that, while only a single CPU 702 is shown in FIG. 7, additional CPUs may be present. Moreover, the computer system 700 may comprise a networked, multi-processor computer system that may include a hybrid parallel CPU/GPU system. The CPU 702 may execute the various logical instructions according to various teachings disclosed herein. For example, the CPU 702 may execute machine-level instructions for performing processing according to the operational flow described.

The computer system 700 may also include computer components such as non-transitory, computer-readable media. Examples of computer-readable media include computer-readable non-transitory storage media, such as a random-access memory (RAM) 706, which may be SRAM, DRAM, SDRAM, or the like. The computer system 700 may also include additional non-transitory, computer-readable storage media such as a read-only memory (ROM) 708, which may be PROM, EPROM, EEPROM, or the like. RAM 706 and ROM 708 hold user and system data and programs, as is known in the art. The computer system 700 may also include an input/output (I/O) adapter 710, a graphics processing unit (GPU) 714, a communications adapter 722, a user interface adapter 724, a display driver 716, and a display adapter 718.

The I/O adapter 710 may connect additional non-transitory, computer-readable media such as storage device(s) 712, including, for example, a hard drive, a compact disc (CD) drive, a floppy disk drive, a tape drive, and the like to computer system 700. The storage device(s) may be used when RAM 706 is insufficient for the memory requirements associated with storing data for operations of the present techniques. The data storage of the computer system 700 may be used for storing information and/or other data used or generated as disclosed herein. For example, storage device(s) 712 may be used to store configuration information or additional plug-ins in accordance with the present techniques. Further, user interface adapter 724 couples user input devices, such as a keyboard 728, a pointing device 726 and/or output devices to the computer system 700. The display adapter 718 is driven by the CPU 702 to control the display on a display device 720 to, for example, present information to the user such as subsurface images generated according to methods described herein.

The architecture of computer system 700 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 700 may include various plug-ins and library files. Input data may additionally include configuration information.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

1. A method for automatically crimping a multi-wire cable using a crimping machine, the crimping machine including an applicator in which the crimping is performed, the method comprising:
after spreading a plurality of wires in the multi-wire cable, performing one or more automatic operations on at least one of the plurality of wires in preparation for insertion of a respective wire into the applicator of the crimping machine; and
automatically inserting the respective wire into the applicator of the crimping machine.

2. The method of claim 1, wherein the one or more automatic operations comprises automatically manipulating a single wire of the plurality of wires in order for the respective wire to be further distanced from an adjacent wire.

3. The method of claim 2, wherein, after spreading the wires, the one or more automatic operations comprises both automatically manipulating the single wire and automatically simultaneously manipulating the plurality of wires.

4. The method of claim 1, wherein the one or more automatic operations comprises automatically simultaneously manipulating each of the plurality of wires.

5. The method of claim 4, wherein the applicator comprises a chamber that defines an axis in which the crimping is performed; and
wherein automatically simultaneously manipulating each of the plurality of wires comprises rotating an end of the multi-wire cable so that each of the plurality of wires moves simultaneously and so that the respective wire of the plurality of wires is aligned with the axis of the chamber.

6. The method of claim 1, further comprising determining, using machine vision, a sequence of crimping of the plurality of wires; and
wherein, responsive to determining the sequence of crimping, performing the one or more automatic operations and automatically inserting the plurality of wires into the applicator in the sequence.

7. The method of claim 6, wherein the multi-wire cable includes wires of at least a first type having a first crimp contact and a second type having a second crimp contact; and
wherein the machine vision determines the sequence based on which of the plurality of wires are of the first type and which are of the second type.

8. The method of claim 6, wherein the sequence is determined by:
using the machine vision to analyzes the spreading of the plurality of the wires; and
using a predetermined ordering and the analysis of the machine vision in order to determine the sequence.

9. The method of claim 6, wherein the spreading of the plurality of wires comprises at least two wires on each end and at least one wire therebetween; and
wherein the sequence comprises beginning with crimping the at least one wire therebetween.

10. The method of claim 1, wherein the respective wire is automatically inserted into the applicator at least partly while holding an exterior of the multi-wire cable and without the respective wire being held with any device.

11. The method of claim 1, wherein after the respective wire is crimped with a crimp contact and withdrawn from the applicator, automatically individually moving the respective wire so that the respective wire touches at least one other wire that has already been crimped.

12. The method of claim 1, wherein, after insertion of the respective wire into the applicator of the crimping machine such that the respective wire is positioned over a crimp contact, automatically positioning the respective wire to be a predetermined distance over the crimp contact.

13. The method of claim 1, further comprising, after automatically inserting the respective wire into the applicator, automatically crimping the respective wire with a crimp contact; and
after automatically crimping the respective wire with a crimp contact, automatically removing the respective wire from the applicator.

14. An automatic robotic system configured for integration with a crimping machine that includes an applicator in which crimping is performed, the automatic robotic system comprising:
one or more motors;
one or more sensors;
at least one processor in communication with the one or more motors and the one or more sensors, the at least one processor configured to:
command the one or more motors, based on information generated by the one or more sensors, in order to automatically manipulate at least one wire in a multi-wire cable in preparation for automatically inserting a respective wire for crimping into the applicator; and
command the one or more motors to automatically insert the respective wire into the applicator in order to crimp the respective wire by the crimping machine.

15. The automatic robotic system of claim 14, wherein the at least one processor is configured to automatically manipulate the at least one wire in the multi-wire cable by automatically individually manipulating a single wire in the multi-wire cable.

16. The automatic robotic system of claim 15, further comprising a pin-like device configured to move using the one or more motors; and
wherein the at least one processor is configured to control the pin-like device so that the pin-like device imparts a force on the single wire to individually manipulate the single wire.

17. The automatic robotic system of claim 14, wherein the processor is configured to automatically manipulate the at least one wire in the multi-wire cable by automatically simultaneously moving each of the wires of the multi-wire cable.

18. The automatic robotic system of claim 14, further comprising a gripper configured to move using the one or more motors; and
wherein the processor is configured to automatically simultaneously move each of the wires of the multi-wire cable by automatically controlling the gripper to grip the multi-wire cable and rotate the multi-wire cable about a rotation axis.

19. The automatic robotic system of claim 14, wherein the crimping machine comprises an at least partially manually-operated crimping machine;
wherein the crimping machine is configured for a manual insertion of a respective wire for crimping by the at least partially manually-operated crimping machine;
wherein the at least one processor is configured to command the one or more motors to automatically insert the respective wire into the applicator in order to crimp the respective wire by the at least partially manually-operated crimping machine; and
wherein the at least one processor is further configured to, after commanding the one or more motors to automatically insert the respective wire, send a communication to the at least partially manually-operated crimping machine to perform the crimping, wherein, responsive to receipt of the communication, the at least partially manually-operated crimping machine is configured to perform the crimping.

20. An automatic crimping machine comprising:
one or more motors;
one or more sensors;
an applicator configured to crimp a crimp contact to a respective wire using a crimp die and a crimp anvil; and
at least one processor in communication with the one or more motors and the one or more sensors, the at least one processor configured to:
command the one or more motors, based on information generated by the one or more sensors, in order to automatically manipulate at least one wire in a multi-wire cable in preparation for automatically inserting the respective wire for crimping into the applicator;
command the one or more motors to automatically insert the respective wire into the applicator in order to crimp the respective wire using a crimp contact;
command to automatically crimp, using the applicator, the respective wire; and
command the one or more motors to automatically remove the respective wire from the applicator.

21. The automatic crimping machine of claim 20, wherein the at least one processor is configured to automatically manipulate the at least one wire in the multi-wire cable by automatically individually manipulating a single wire in the multi-wire cable.

22. The automatic crimping machine of claim 20, further comprising a gripper configured to move using the one or more motors;
wherein the processor is configured to automatically simultaneously move each of the wires of the multi-wire cable in one or more of the following directions: an X-direction; a Y-direction; a rotational direction; or a Z-direction, wherein the rotational direction is in an X-Y plane, wherein the respective wire is inserted into the applicator in the Y-direction, and wherein after insertion of the respective wire into the applicator, a distance of the crimp contact within the applicator to the respective wire is in the Z-direction.

23. The automatic crimping machine of claim 22, wherein the processor is configured to automatically simultaneously move each of the wires of the multi-wire cable by automatically controlling the gripper to grip the multi-wire cable and rotate the multi-wire cable about a rotation axis.

24. The automatic crimping machine of claim 20, wherein the one or more sensors comprise one or more cameras;
wherein the one or more cameras are configured to generate an image of a side view of the applicator to indicate a position of the respective wire along an axis formed by a chamber of the applicator and to indicate a position of the respective wire relative to the crimp contact positioned in the chamber of the applicator; and
wherein the at least one processor, using the image of the side view, is configured to command movement so that the respective wire is at a predetermined position along the axis formed by the chamber and at a predetermined distance from the crimp contact when positioned within the chamber.
